(19) United States
(12) Patent Application Publication
(10) Pub. No.: US 2026/0230807 A1
(43) Pub. Date: Aug. 6, 2026

(54) VIRTUAL BASIC SERVICE SET TECHNIQUES

(71) Applicant: QUALCOMM Incorporated, San Diego, CA (US)

(72) Inventors: Gyanranjan HAZARIKA, Milpitas, CA (US); Samanth MANJUNATH, Fremont, CA (US); Xiaolong HUANG, Santee, CA (US); Manish SHUKLA, Milpitas, CA (US); Sandip HOMCHAUDHURI, San Jose, CA (US); Prem THILAGAR, Chennai (IN); Sujatha VARADARAJAN, Chennai (IN); Viren UMRIGAR, Dublin, CA (US); Adil Saeed MUSTHAFA, Milpitas, CA (US)

(21) Appl. No.: 19/045,433

(22) Filed: Feb. 4, 2025

(51) Int. Cl. H04W 12/00; H04W 12/04; H04W 88/08

(52) U.S. Cl. CPC H04W 12/009; H04W 12/04; H04W 88/08

(57) ABSTRACT

This disclosure provides methods, components, devices and systems for virtualized basic service set (VBSS) techniques. Some aspects relate to establishment of a VBSS for a client wireless communication device and the exchanging of client wireless communication device parameters associated with establishment of the VBSS. A VBSS may enable a network to follow a client wireless communication device as the client wireless communication device transitions from a source access point (AP) to a destination AP. Client wireless communication device parameters may include security context parameters, operating parameters, and/or multi-link operation parameters. One or more information elements or type length value fields in a security context response message sent from the source AP to the VBSS controller may include security context, operating, and/or MLO. One or more IEs or TLVs in a VBSS request message sent from the VBSS controller to the destination AP may include security context, operating, and/or MLO parameters.

### TECHNICAL FIELD

This disclosure relates generally to wireless communication and, more specifically, to virtual basic service set techniques.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a first wireless communication device. The method may include receiving, from a first access point (AP) and in association with transfer of service for a client wireless communication device from the first AP to a second AP in association with a virtual basic service set (VBSS), one or more first messages that indicate a set of security context parameters associated with the client wireless communication device and a set of operating parameters associated with the client wireless communication device and transmitting, to the second AP in association with the one or more first messages, one or more second messages that indicate the set of security context parameters and the set of operating parameters.

Another innovative aspect of the subject matter described in this disclosure can be implemented in a first wireless communication device for wireless communications. The first wireless communication device may include a processing system that includes processor circuitry and memory circuitry that stores code. The processing system may be configured to cause the first wireless communication device to receive, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device and transmit, to the second AP in association with the one or more first messages, one or more second messages that indicate the set of security context parameters and the set of operating parameters.

Another innovative aspect of the subject matter described in this disclosure can be implemented in a first wireless communication device for wireless communications. The first wireless communication device may include means for receiving, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device and means for transmitting, to the second AP in association with the one or more first messages, one or more second messages that indicate the set of security context parameters and the set of operating parameters.

Another innovative aspect of the subject matter described in this disclosure can be implemented in a non-transitory computer-readable medium storing code for wireless communications. The code may include instructions executable by one or more processors to receive, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device and transmit, to the second AP in association with the one or more first messages, one or more second messages that indicate the set of security context parameters and the set of operating parameters.

Some examples of the method, first wireless communication devices, and non-transitory computer-readable medium described herein may further include operations, features, means, or instructions for transmitting, to the first AP, a client security context request message and receiving, from the first AP and in response to the client security context request message, a client security context response message that includes the set of security context parameters, the one or more first messages including the client security context response message.

In some examples of the method, first wireless communication devices, and non-transitory computer-readable medium described herein, the client security context response message includes a client security context information element (IE) that includes a beacon interval group temporal key parameter, an integrity group temporal key, a pairwise master key parameter, a receiver packet number parameter, or a combination thereof.

Some examples of the method, first wireless communication devices, and non-transitory computer-readable medium described herein may further include operations, features, means, or instructions for transmitting, to the second AP, a VBSS request message that includes an extended VBSS IE, the extended VBSS IE including the beacon interval group temporal key parameter, the integrity group temporal key, the pairwise master key parameter, the receiver packet number parameter, or the combination thereof, the one or more second messages including the VBSS request message.

Some examples of the method, first wireless communication devices, and non-transitory computer-readable medium described herein may further include operations, features, means, or instructions for transmitting, to the second AP, a VBSS request message that includes an extended VBSS IE and the client additional security context IE.

In some examples of the method, first wireless communication devices, and non-transitory computer-readable medium described herein, the one or more first messages include a client operation report IE associated with the set of operating parameters, the client operation report IE including a receiver number of spatial streams type parameter, a receiver number of spatial streams parameter, a low density parity check encoding parameter, a channel width parameter, a spatial multiplexing power saving parameter, one or more individual target wake time parameters, one or more broadcast target wake time parameters, or a combination thereof.

Some examples of the method, first wireless communication devices, and non-transitory computer-readable medium described herein may further include operations, features, means, or instructions for transmitting, to the second AP, a VBSS request message that includes the client operation report IE, the one or more second messages including the VBSS request message.

Another innovative aspect of the subject matter described in this disclosure can be implemented in a method for wireless communications by a first AP. The method may include receiving, from a first wireless communication device, one or more request messages associated with transfer of service for a client wireless communication device from the first AP to a second AP in accordance with a VBSS, the VBSS associated with the first AP and the second AP and transmitting, to the first wireless communication device, one or more first messages that indicate a set of security context parameters associated with the client wireless communication device and a set of operating parameters associated with the client wireless communication device.

Another innovative aspect of the subject matter described in this disclosure can be implemented in a first AP for wireless communications. The first AP may include a processing system that includes processor circuitry and memory circuitry that stores code. The processing system may be configured to cause the first AP to receive, from a first wireless communication device, one or more request messages associated with transfer of service for a client wireless communication device from the first AP to a second AP in accordance with a VBSS, the VBSS associated with the first AP and the second AP and transmit, to the first wireless communication device, one or more first messages that indicate a set of security context parameters associated with the client wireless communication device and a set of operating parameters associated with the client wireless communication device.

Another innovative aspect of the subject matter described in this disclosure can be implemented in a first AP for wireless communications. The first AP may include means for receiving, from a first wireless communication device, one or more request messages associated with transfer of service for a client wireless communication device from the first AP to a second AP in accordance with a VBSS, the VBSS associated with the first AP and the second AP and means for transmitting, to the first wireless communication device, one or more first messages that indicate a set of security context parameters associated with the client wireless communication device and a set of operating parameters associated with the client wireless communication device.

Another innovative aspect of the subject matter described in this disclosure can be implemented in a non-transitory computer-readable medium storing code for wireless communications. The code may include instructions executable by one or more processors to receive, from a first wireless communication device, one or more request messages associated with transfer of service for a client wireless communication device from the first AP to a second AP in accordance with a VBSS, the VBSS associated with the first AP and the second AP and transmit, to the first wireless communication device, one or more first messages that indicate a set of security context parameters associated with the client wireless communication device and a set of operating parameters associated with the client wireless communication device.

Some examples of the method, first APs, and non-transitory computer-readable medium described herein may further include operations, features, means, or instructions for receiving, from the first wireless communication device, a client security context request message, the one or more request messages including the client security context request message and transmitting, to the first wireless communication device in association with the client security context request message, a client security context response message that includes the set of security context parameters, the one or more first messages including the client security context response message.

In some examples of the method, first APs, and non-transitory computer-readable medium described herein, the client security context response message includes a client security context IE that includes a beacon interval group temporal key parameter, an integrity group temporal key, a pairwise master key parameter, a receiver packet number parameter, or a combination thereof.

In some examples of the method, first APs, and non-transitory computer-readable medium described herein, the one or more first messages include a client operation report IE associated with the set of operating parameters, the client operation report IE including a receiver number of spatial streams type parameter, a receiver number of spatial streams parameter, a low density parity check encoding parameter, a channel width parameter, a spatial multiplexing power saving parameter, one or more individual target wake time parameters, one or more broadcast target wake time parameters, or a combination thereof.

A method for wireless communications by a second AP is described. The method may include receiving, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device and communicating with the client wireless communication device in accordance with the VBSS in association with the one or more messages.

Another innovative aspect of the subject matter described in this disclosure can be implemented in a second AP for wireless communications. The second AP may include a processing system that includes processor circuitry and memory circuitry that stores code. The processing system may be configured to cause the second AP to receive, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device and communicate with the client wireless communication device in accordance with the VBSS in association with the one or more messages.

Another innovative aspect of the subject matter described in this disclosure can be implemented in a second AP for wireless communications. The second AP may include means for receiving, from a first wireless communication device, one or more messages associated with transfer of service for a client wireless communication device from a first AP to the second AP in association with a VBSS, where the one or more first messages indicate a set of security context parameters associated with the client wireless communication device and a set of operating parameters associated with the client wireless communication device and means for communicating with the client wireless communication device in accordance with the VBSS in association with the one or more messages.

Another innovative aspect of the subject matter described in this disclosure can be implemented in a non-transitory computer-readable medium storing code for wireless communications. The code may include instructions executable by one or more processors to receive, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device and communicate with the client wireless communication device in accordance with the VBSS in association with the one or more messages.

Some examples of the method, second APs, and non-transitory computer-readable medium described herein may further include operations, features, means, or instructions for receiving, from the first wireless communication device, a VBSS request message that includes an extended VBSS IE, the extended VBSS IE including a beacon interval group temporal key parameter, an integrity group temporal key, a pairwise master key parameter, a receiver packet number parameter, or a combination thereof, the one or more messages including the VBSS request message.

Some examples of the method, second APs, and non-transitory computer-readable medium described herein may further include operations, features, means, or instructions for receiving, from the first wireless communication device, a VBSS request message that includes a client security context IE and a client additional security context IE, the client additional security context IE including a beacon interval group temporal key parameter, an integrity group temporal key, a pairwise master key parameter, a receiver packet number parameter, or a combination thereof, the one or more messages including the VBSS request message.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer (PHY) protocol data unit (PPDU) usable for communications between a wireless AP and one or more wireless STAs.

FIG. 4 shows an example of a signaling diagram that supports virtual basic service set (VBSS) techniques.

FIG. 5 shows an example of a process flow associated with addition of a client device to a VBSS in accordance with VBSS techniques.

FIG. 6 shows an example of a process flow associated with transfer of service from a first AP to a second AP that supports VBSS techniques.

FIG. 7 shows a block diagram of an example wireless communication device that supports VBSS techniques.

FIG. 8 shows a flowchart illustrating an example process performable by or at a first wireless communication device that supports VBSS techniques.

FIG. 9 shows a flowchart illustrating an example process performable by or at a first access point that supports VBSS techniques.

FIG. 10 shows a flowchart illustrating an example process performable by or at a second access point that supports VBSS techniques.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a client wireless communication device, such as a wireless station (STA), may move through coverage areas serviced by different access points (APs). Each AP may be associated with a basic service set (BSS). For example, in an office building with multiple APs, a client device may move from a location where service is provided by a first AP to a location where service is provided by a second AP (such as from one floor to another floor, or from one side of a floor to another side of the floor). Disconnecting from the first AP before connecting and associating with the second AP may involve latency. A virtual BSS (VBSS) may be a set of multiple APs in a mesh network that coordinate to enable a network connection with a client wireless communication device of the mesh network (such as a STA) to move from connection with one AP to another AP without disconnecting from the network. A VBSS may be implemented to enable a network to follow a client wireless communication device as the client wireless communication device transitions from a first AP to a second AP enabling a more seamless connection. In comparison, as described herein, transitioning between BSSs in a non-VBSS scenario may involve first disconnecting the client wireless communication device from the source AP before connecting and associating with the target AP. A VBSS may include a VBSS controller (such as a master AP) and one or more other APs. In order to establish a connection between a client wireless communication device and an AP, some client wireless communication device parameters, such as operating parameters and security context parameters may be established between the client wireless communication device and the AP.

Various aspects relate generally to establishment of a VBSS for a client wireless communication device and the exchanging of client wireless communication device parameters associated with establishment of the VBSS, for example, in order to enable the client wireless communication device to seamlessly transition to a connection with the target AP. Some aspects more specifically relate to the collection from the source AP and transfer to the destination AP of security context parameters such as a beacon interval group temporal key (BI GTK) parameter, an integrity group temporal key (IGTK), a pairwise master key (PMK) parameter, and a receiver packet number parameter. Some aspects more specifically relate to the collection from the source AP and transfer to the destination AP of operating parameters of the client wireless communication device such as a receiver number of spatial streams (NSS) type parameter, a receiver number of spatial streams (NSS) parameter, a low density parity check (LDPC) encoding parameter, a channel width parameter, a spatial multiplexing power saving (SMPS) parameter, one or more individual target wake time (TWT) parameters, or one or more broadcast target wake time parameters. In some examples, a client wireless communication device may communicate in accordance with a multi-link operation (MLO). Some aspects accordingly may relate to the collection from the source AP and transfer to the destination AP of MLO parameters such as the MAC addresses and the quantity of links. In some aspects, one or more information elements (IEs) or type length value (TLV) fields in a security context response message sent from the source AP to the VBSS controller may include such security context parameters, operating parameters, and/or MLO parameters. In some aspects, one or more IEs or TLVs in a VBSS request message sent from the VBSS controller to the destination AP may include such security context parameters, operating parameters, and/or MLO parameters.

Particular aspects of the subject matter described in this disclosure can be implemented to realize one or more of the following potential advantages. In some examples, by extracting security context parameters and operating parameters from the source AP and providing such parameters to a destination AP, passing of service for a client wireless communication device from the source AP to the destination AP may be seamless, as compared to a latency of 50 milliseconds (ms) to 100 ms for a roaming type transfer of service (where roaming may involve first disconnecting from the source AP before connecting with the target AP). For example, VBSSs may be used in environments with multiple APs to maintain continuous connectivity with the client wireless communication device and thus improve user experience. VBSSs also may reduce the occurrences of “sticky clients” via preventing client wireless communication devices from sticking to a single AP during network steering, enabling smoother transitions. Additionally, or alternatively, by extracting MLO parameters and providing such parameters to a destination AP, service involving an MLO may similarly be seamlessly transferred without re-establishing the MLO at the destination AP. MLO may increase bandwidth of the connection between the AP and the client wireless communication device. Additionally, or alternatively, by defining IEs or TLVs in security context messages or VBSS request messages, the source and destination APs as well as the VBSS controller may expect which messages and fields include such parameters for transfer of service in accordance with a VBSS.

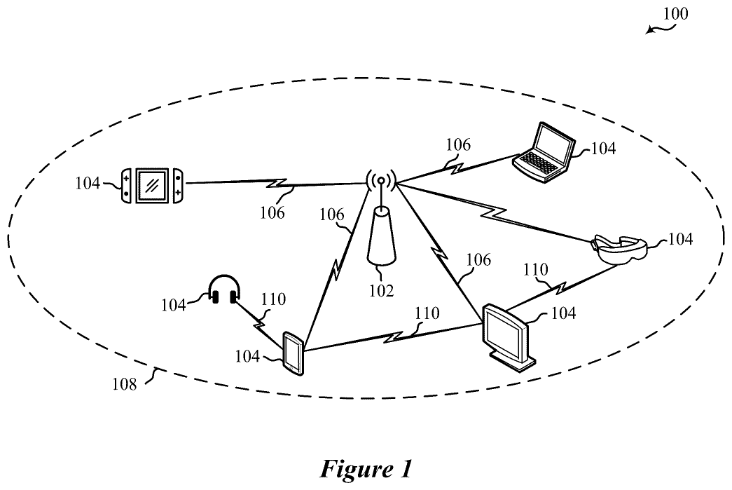

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected

BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHZ-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

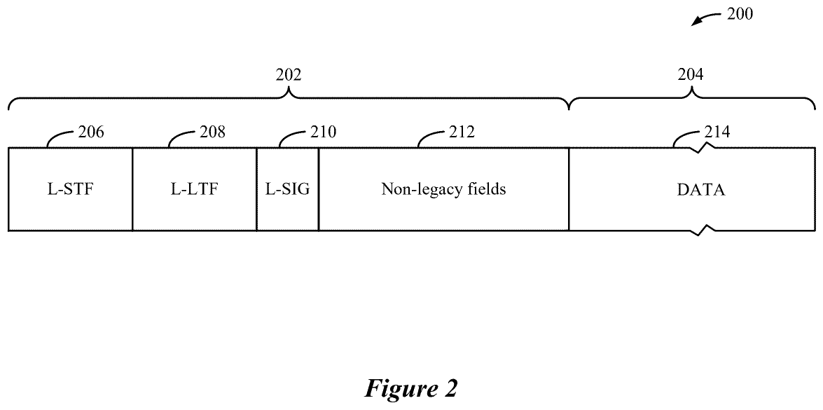

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

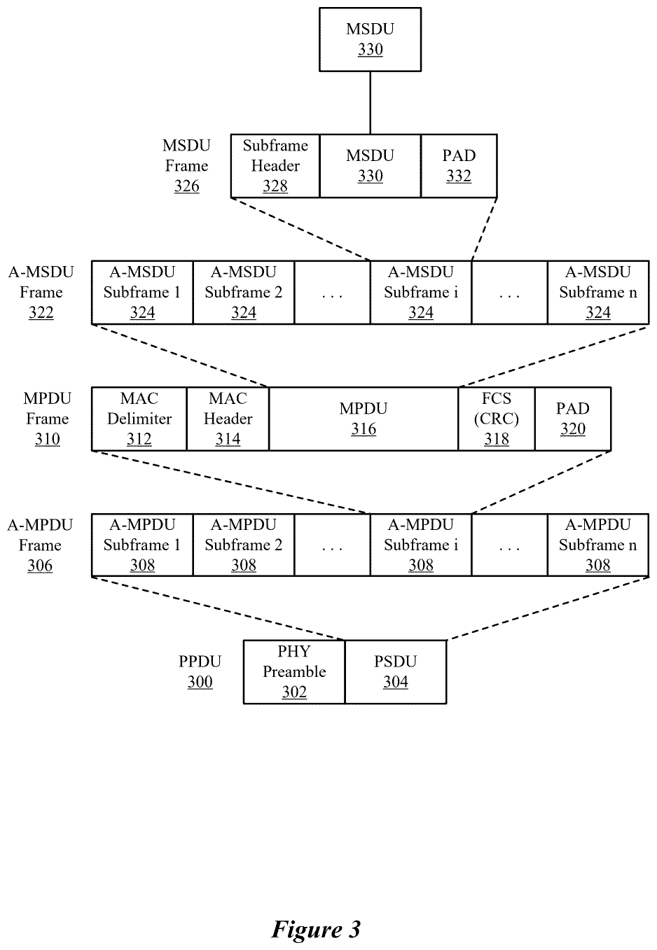

FIG. 3 shows a hierarchical format of an example physical layer (PHY) protocol data unit (PPDU) usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

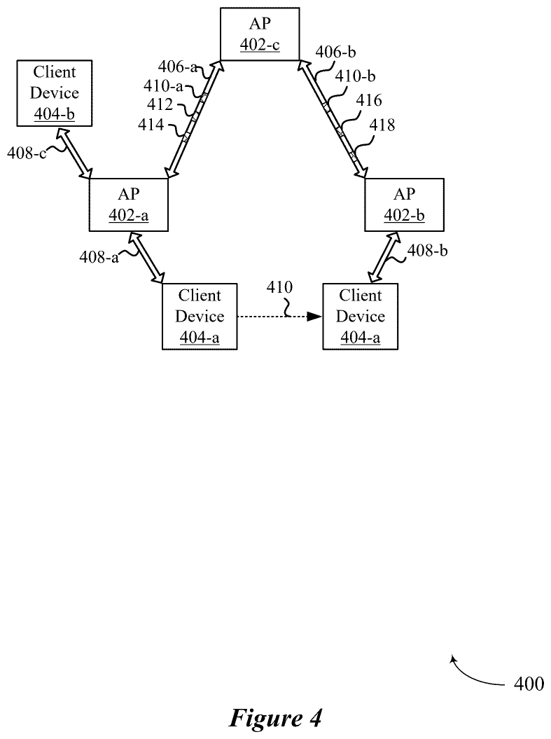

FIG. 4 shows an example of a signaling diagram 400 that supports techniques for management of communication with a client wireless communication device in accordance with a VBSS. The signaling diagram 400 may implement or may be implemented by aspects of the wireless communication network 100. For example, the signaling diagram 400 includes a first AP 402-a, a second AP 402-b, and a third AP 402-c, which may be examples of APs 102 as described with reference to FIG. 1. As another example, the signaling diagram 400 includes a client wireless communication device 404-a and a client wireless communication device 404-b, which may be examples of STAs 104 as described with reference to FIG. 1. The first AP 402-a may communicate with the third AP 402-c via a communication link 406-a. The second AP 402-b may communicate with the third AP 402-c via a communication link 406-b. The first AP 402-a, the second AP 402-b, and the third AP 402-c may implement a VBSS that may enable seamless communication with the client wireless communication device 404-a as the client wireless communication device 404-a moves throughout a physical area which is serviced by the first AP 402-a, the second AP 402-b, and/or the third AP 402-c.

The first AP 402-a may communicate at a first time with the client wireless communication device 404-a via a communication link 408-a and with the client wireless communication device 404-b via a communication link 408-c. For example, the first AP 402-a may exchange one or more PDUs 200 as described with reference to FIG. 2 or one or more PPDUs 300 as described with reference to FIG. 3 with the client wireless communication device 404-a and the client wireless communication device 404-b via the communication link 408-a and the communication link 408-c, respectively. The first AP 402-a may communicate with the client wireless communication device 404-b via a regular BSS. The client wireless communication device 404-a may move along a path 410, and accordingly at a second time the signal strength between the client wireless communication device 404-a and the second AP 402-b may be better than the signal strength between the client wireless communication device 404-a and the first AP 402-a. The first AP 402-a, the second AP 402-b, and the third AP 402-c may implement a VBSS to enable the network to follow the client wireless communication device 404-a as the client wireless communication device 404-a transitions from the first AP 402-a (for example, from communication via the communication link 408-a) to the second AP 402-b (for example, to communication via the communication link 408-b). The third AP 402-c may be a VBSS controller of the VBSS, and may also be referred to as a first wireless communication device. A VBSS may be implemented in scenarios with multiple APs 402, as in the signaling diagram 400. VBSS may reduce the disruption associated with transfer of service from 50-100 ms from one BSS to another BSS to around 10 ms. Some aspects of VBSS may be defined in the Wi-Fi Alliance Wi-Fi EasyMesh Specification v5+.

In some aspects, the third AP 402-c may determine whether to transfer service for the client wireless communication device 404-a from the first AP 402-a to the second AP 402-b in accordance with the VBSS based on algorithms that may be based on relative signal strengths of links between the APs 402 and the client wireless communication device 404-a. For example, the first AP 402-a may obtain a measurement of a first signal strength of a link between the first AP 402-a and the client wireless communication device 404-a (for example, based on reporting of measurements of beacons transmitted by the first AP 402-a or based on measurements of transmissions by the client wireless communication device 404-a), and the first AP 402-a may transmit a report 410-a to the third AP 402-c that indicates the measurement of the first signal strength. Similarly, the second AP 402-b may obtain a measurement of a second signal strength of a link between the second AP 402-b and the client wireless communication device 404-a (for example, based on reporting of measurements of beacons transmitted by the second AP 402-b or based on measurements of transmissions by the client wireless communication device 404-a), and the second AP 402-b may transmit a report 410-b to the third AP 402-c that indicates the measurement of the second signal strength. In some examples, the third AP 402-c may determine whether to transfer service for the client wireless communication device 404-a from the first AP 402-a to the second AP 402-b based on QoS requirements and/or service level agreements (SLAs) for traffic flows associated with the client wireless communication device 404-a. For example, the third AP 402-c may determine whether the communication link 408-a between the client wireless communication device 404-a and the first AP 402-a or the communication link 408-b between the client wireless communication device 404-a and the second AP 402-b is better able to meet the QoS requirements and/or SLAs for the client wireless communication device 404-a (for example, based on relative signal strengths of the communication links 408, traffic or congestion on the communication links 408, quantity of client devices on each of the communication links 408). In some examples, the third AP 402-c may determine whether to transfer service for the client wireless communication device 404-a from the first AP 402-a to the second AP 402-b based on parameters such as path capacity of the communication links 408 or whether there is an SLA breach on the communication link 408-a.

To transfer service for the client wireless communication device 404-a from the first AP 402-a to the second AP 402-b in accordance with the VBSS, the third AP 402-c (which, in some examples, may be the VBSS controller) may transmit a security context request message 412 to the first AP 402-a. In response to the security context request message 412, the first AP 402-a may transmit a security context response message 414 to the third AP 402-c. The security context response message 414 may include IEs or TLV fields that indicate security context and/or operating parameters associated with the communication link 408-a between the client wireless communication device 404-a and the first AP 402-a. The third AP 402-c may transmit a VBSS request message 416 to the second AP 402-b. The VBSS request message 416 may include IEs or TLV fields that indicate the security context and/or operating parameters to enable the second AP 402-b to seamlessly establish the communication link 408-b with the client wireless communication device 404-a. In some examples, the second AP 402-b may transmit an acknowledgment 418 to the third AP 402-c to acknowledge the VBSS request message 416 and/or to indicate that the second AP 402-b established communication with the client wireless communication device 404-a via the communication link 408-b in accordance with the parameters in the VBSS request message 416.

In some examples, the security context response message 414 may include a client security context TLV for the client wireless communication device 404-a. As described herein, the third AP 402-c (the VBSS controller) may forward the contents of the client security context TVL via an extended VBSS creation TLV in the VBSS request message 416. Fields defined in the Wi-Fi EasyMesh Specification v5+ for the client security context TLV and the extended VBSS creation TLV may be insufficient for a complete security context transfer during a VBSS client wireless communication device transfer/move. For example, Table 1 shows the fields in the client security context TLV as defined in the Wi-Fi EasyMesh Specification v5+.

TABLE 1

| | | | |
|---|---|---|---|
| Key Length | 2 octets | Unsigned Integer | Key Length in |
| | | | octets |
| Pairwise temporal | Variable | Variable | Pairwise temporal |
| key (PTK) | | | key |
| Tx Packet Number | 2 octets | Unsigned Integer | Group Key Length |
| | | | in octets |
| Group temporal | Variable | Variable | Group Temporal |
| key (GTK) | | | Key |
| Group Tx Packet | 8 Octets | Unsigned Integer | Group Tx Packet |
| Number | | | Number |

In some examples, the client security context TLV in the security context response message 414 may include a BI GTK field, a PMK field, an I GTK, and a receiver packet number parameter, as shown in Table 2 to complete the security context TLV. Similarly, the extended VBSS creation TLV in the VBSS request message 416 may include the BI GTK field, a PMK field, an I GTK and a receiver packet number parameter, as shown in Table 3 to complete the extended VBSS creation TLV.

TABLE 2

| Field | Length | Value | Description |
|---|---|---|---|
| tlvType | 1 octet | 0xDE | |
| tlvLength | 2 octets | Variable | Number of octets in ensuing |
| | | | field. |
| tlvValue | | | |
| tlvSubType | 2 octets | 0x0005 | |
| Client | bit 7 | 0 or 1 | Indicates whether client is |
| Connected? | | | connected to network. If 1, |
| | | | client is connected to network. |
| | | | If 0, client is not connected or |
| | | | is in the process of connecting. |
| | bit 6-0 | 0 | Reserved |
| Key Length | 2 octets | Variable | Key Length in octets-if the |
| | | | network is open, then this field |
| | | | is 0. |
| PTK | Variable | Variable | Pairwise Temporal Key |
| Tx Packet | 8 octets | Unsigned | Tx Packet Number (TXPN) |
| Number | | Integer | |
| Group Key | 2 octets | Unsigned | Group Key Length in octets |
| Length | | Integer | |
| GTK | Variable | Variable | Group Temporal Key |
| Group Tx | 8 octets | Unsigned | Group Tx Packet Number |
| Packet Num | | Integer | |
| BI GTK | Variable | Variable | GTK for Beacon protection, |
| | | | which is mandatory for 6G |
| IGTK | Variable | Variable | I GTK |
| PMK | Variable | Variable | Pairwise Master Key |
| Rx Packet | 8 octets | Unsigned | Rx Packet Number (RXPN) |
| Number | | Integer | |

TABLE 3

| Field | Length | Value | Description |
|---|---|---|---|
| tlvType | 1 octet | 0xDE | |
| tlvLength | 2 octets | Unsigned Integer | Number of octets in ensuing field. |

tlvValue:

| tlvSubType | 2 octets | 0x0008 | |
|---|---|---|---|
| RUID | 6 octets | Variable | Radio Unique Identifier (RUID) of a |
| | | | radio of the Multi-AP Agent. |
| BSSID | 6 octets | Variable | BSSID |
| SSID Length | 2 octets | Unsigned | SSID Length |
| | | Integer | |
| SSID | Variable | String | SSID |
| Authentication | 2 octets | Unsigned | Authentication Type from Table 32 of |
| Type | | Integer | [3] extended with the following: |
| | | | 0x0040 SAE (Simultaneous |
| | | | Authentication of Equals) (WPA3 |
| | | | (Wi-Fi Protected Access 3)) |
| | | | 0x0060 SAE & WPA2 PSK (Transition Mode) |
| | | | 0x0100 DPP (Device provisioning protocol) |
| Pass Length | 2 octets | Unsigned | Password/Passphrase Length-0 |
| | | Integer | indicates that the WPA2 or SAE Pass is |
| | | | not present |
| Pass | Variable | String | WPA2 or SAE Passphrase/password |
| Encryption OUI | 3 octets | Octet | Any OUI value specified in Table 9- |
| | | Array | 151 of [1] or Table 56 of [4]. |
| Encryption Suite | 2 octets | Unsigned | Any suite type value specified in Table |
| Type | | Integer | 9-151 of [1] or Table 56 of [4]. |
| DPP Connector | 2 octets | Unsigned | Length of DPP Connector String, 0 |
| Length | | Integer | indicates that DPP Connector is not |
| | | | present |
| DPP Connector | Variable | String | DPP Connector string |
| Client MAC | 6 octets | Octet | Client's MAC that this virtual BSS |
| | | Array | exists to serve. |
| Client Assoc | 1 octet | 0 or 1 | If 1, client is already associated, 0 if |
| | | | client is not yet associated. If this flag |
| | | | is 1 then the security context fields |
| | | | below are populated. If 0, then the |
| | | | security fields below are filled in with |
| | | | 0s. |
| | Security Context fields follow | | |
| Key Length | 2 octets | Unsigned | Key Length in octets |
| | | Integer | |
| PTK | Variable | Variable | Pairwise Temporal Key |
| Tx Packet Num | 8 octets | Unsigned | Tx Packet Number |
| | | Integer | |
| Group Key Length | 2 octets | Unsigned | Group Key Length in octets |
| | | Integer | |
| GTK | Variable | Variable | Group Temporal Key |
| Group Tx Packet | 8 octets | Unsigned | Group Tx Packet Number |
| Num | | Integer | |
| BI GTK | Variable | Unsigned | GTK for Beacon protection, which is |
| | | Integer | mandatory for 6G |
| I GTK | Variable | Unsigned | I GTK |
| | | Integer | |
| Rx Packet Number | 8 octets | Unsigned | Rx Packet Number (RXPN) |
| | | Integer | |
| BI GTK | Variable | Variable | GTK for Beacon protection, which is |
| | | | mandatory for 6G |
| I GTK | Variable | Variable | I GTK |
| PMK | Variable | Variable | Pairwise Master Key |
| Rx Packet Number | 8 octets | Unsigned | Rx Packet Number (RXPN) |
| | | Integer | |

In some examples, the BI GTK field, the PMK field, the I GTK field, and the receiver packet number parameter may be included in a separate TLV than the client security context TLV in the security context response message 414. For example, the security context response message 414 may include one client info TLV (for example, as described in section 17.2.18 of the Wi-Fi EasyMesh Specification v5+), one client security context TLV (for example, as described in section B.5.5 of the Wi-Fi EasyMesh Specification v5+), and one client additional security context TLV which may include the fields shown in Table 4. In some such examples, the VBSS request message 416 may include one extended VBSS creation TLV (for example, as described in section B.4.3 of the Wi-Fi EasyMesh Specification v5+), zero or one client capability report TLVs (for example, as described in section 17.2.19 of the Wi-Fi EasyMesh Specification v5+), and one client additional security context TLV which may include the fields shown in Table 4.

TABLE 4

| Field | Length | Value | Description |
|---|---|---|---|
| tlvType | 1 octet | 0xDE | |
| tlvLength | 2 octets | Variable | Number of octets in ensuing field. |
| tlvValue | | | |
| tlvSubType | 2 octets | TBD | |
| BI GTK | Variable | Variable | GTK for Beacon protection, |
| | | | which is mandatory for 6G |
| I GTK | Variable | Variable | Integrity GTK (IGTK) |
| PMK | Variable | Variable | Pairwise Master Key |
| Rx Packet | 8 octets | Unsigned | Rx Packet Number (RXPN) |
| Number | | Integer | |

In some examples, communication between the client wireless communication device 404-a and the first AP 402-a may include operation parameters that may be dynamically negotiated. Some such operation parameters that may be provided to the second AP 402-b to enable seamless transition from the first AP 402-a to the second AP 402-b for the client wireless communication device 404-a may not be included in the TLVs defined in the Wi-Fi EasyMesh Specification v5+. For example, such operation parameters may include a receiver NSS type parameter, a receiver NSS parameter, an LDPC encoding parameter, a channel width parameter, and a dynamic SMPS mode parameter. In some examples, the security context response message 414 may include one client operation report TLV that includes the fields shown in Table 5. In some such examples, the VBSS request message 416 may include one client operation report TLV that includes the fields shown in Table 5. Accordingly, the third AP 402-c may extract the operation parameters from the first AP 402-a and may provide the extracted operation parameters to the second AP 402-b.

TABLE 5

| Field | Length | Value | Description |
|---|---|---|---|
| tlvType | 1 octet | 0xDE | |
| tlvLength | 2 octets | Variable | Number of octets in |
| | | | ensuing field. |
| tlvValue | | | |
| tlvSubType | 2 octets | TBD | |
| Rx NSS Type | Bit 7 | 0 or 1 | Whether Rx NSS subfield |
| | | | carries the maximum |
| | | | number of spatial streams |
| | | | that the STA can receive in |
| | | | any PPDU. |
| Rx NSS | Bits 6-4 | | This field indicates the |
| | | | maximum number of |
| | | | spatial streams that the |
| | | | STA |
| No LDPC | Bit 3 | 0 or 1 | Indicates whether the STA |
| | | | transmitting this field |
| | | | prefers not to receive |
| | | | LDPC encoded PPDUs |
| 160/80 + 80BW | Bit 2 | 0 or 1 | This subfield, combined |
| | | | with the Channel Width |
| | | | subfield, the Supported |
| | | | Channel Width |
| | | | Set subfield and the |
| | | | Supported VHT (very high |
| | | | throughput)-MCS and NSS |
| | | | Set subfield indicates |
| | | | whether 80 + 80 |
| | | | MHz and 160 MHz |
| | | | operation is supported. |
| Channel Width | Bits 1-0 | | Indicates the supported |
| | | | channel width |
| DynamicClient SMPS | 1 octet | variable | Spatial Multiplexing Power |
| mode | | | Save |
| | | | 0: for Static SM Power |
| | | | Save mode |
| | | | 1: for Dynamic SM Power |
| | | | Save mode |
| | | | 3: when SM Power Save is |
| | | | disabled or not supported. |

In some examples, dynamically negotiated operation parameters related to target wait time (TWT) may not be included in the TLVs defined in the Wi-Fi EasyMesh Specification v5+. For example, such operation parameters may include an individual TWT parameter set field including a request type parameter, a TWT parameter, a TWT group assignment, a TWT wake interval Mantissa parameter, a TWT channel parameter, and/or an neighbor discovery protocol (NDP) paging parameter. As another example, such operation parameters may include a broadcast TWT parameter set field including a request type parameter, a TWT parameter, a nominal minimum TWT wake duration parameter, a TWT wake interval Mantissa parameter, and/or a broadcast TWT info parameter. In some examples, the security context response message 414 may include one client operation report TLV that includes the fields related to the TWT operation parameters shown in Table 6. In some such examples, the VBSS request message 416 may include one client operation report TLV that includes the fields related to the TWT operation parameters shown in Table 6. Accordingly, the third AP 402-c may extract the operation parameters from the first AP 402-a and may provide the extracted operation parameters to the second AP 402-b. In some examples, the parameters in Table 6 may be included in the same client operation report TLV as the parameters in Table 5.

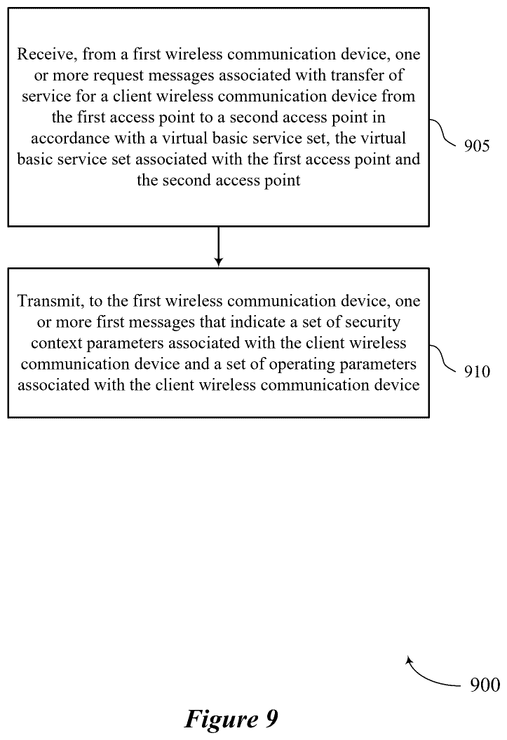

TABLE 6

| Field | Length | Value | Description |
|---|---|---|---|
| tlvType | 1 octet | 0xDE | |
| tlvLength | 2 octets | Variable | Number of octets in ensuing field. |
| tlvValue | | | |
| tlvSubType | 2 octets | TBD | |
| : | : | : | : |
| : | : | : | : |
| : | : | : | : |
| iTWT Valid | 1 octet | 0 or 1 | This field indicates that iTWT |
| | | | Valid and the following few fields |
| | | | shall pertain to iTWT. If this field |
| | | | is set to 0, the iTWT fields shall |
| | | | be skipped. |
| Request Type | 2 octets | Variable | FIG. 9-792- Request Type |
| | | | field format Individual TWT |
| | | | Parameter Set field |
| Target Wake Time | 0 or 8 | Variable | Target Wake Time |
| | octets | | |
| TWT Group | 0, 3 or 9 | Variable | TWT Group Assignment |
| Assignment | octets | | |
| Nominal Minimum | 1 octet | Variable | Nominal Minimum TWT Wake |
| TWT Wake Duration | | | Duration |
| TWT Wake Interval | 2 octets | Variable | TWT Wake Interval Mantissa |
| Mantissa | | | |
| TWT Channel NDP | 0 or 4 | Variable | TWT Channel NDP Paging |
| Paging(Optional) | octets | | (Optional) |
| bTWT Valid | 1 octet | 0 or 1 | This field indicates whether |
| | | | bTWT is Valid and the following |
| | | | few fields shall pertain to bTWT. |
| | | | If this field is set to 0, the bTWT |
| | | | fields shall be skipped. |
| Request Type | 2 octets | Variable | FIG. 9-793-Request Type |
| | | | field format in Broadcast TWT |
| | | | Parameter Set field |
| Target Wake Time | 2 octets | Variable | Target Wake Time |
| Nominal Minimum | 1 octet | Variable | Nominal Minimum TWT Wake |
| TWT Wake Duration | | | Duration |
| TWT Wake Interval | 2 octets | Variable | TWT Wake Interval Mantissa |
| Mantissa | | | |
| Broadcast TWT info | 2 octets | Variable | Broadcast TWT Info |

As described herein, some wireless communications devices such as APs 402 and/or client wireless communication devices 404 (which may be STAs 104 as described herein) may support MLO. For example, the communication link 408-a may be a multi-link communication link over multiple frequency bands. In some examples, the extended VBSS creation TLV may include MLO virtual AP (VAP) configurations and/or MLO client information, such as the security context transfer per link, the client operation report fields per link, and/or the traffic identifier (TID) to link (T2L) context transfer. MLO parameters may include VBSS client-specific parameters and VBSS-specific parameters.

In some examples, the client security context TLV in the security context response message 414 may include a MLO client security context TLV that includes VBSS client-specific fields associated with MLO operation as shown in Table 7 including the MLD_MAC_Addr field indicative of a MAC address of the MLD, a NUM_Affiliated field indicative of the quantity of affiliated links for the MLD, and link-specific fields such as an RUID field indicative of the radio unique identifier of the multi-AP agent. Some fields shown in Table 7 may be provided per link of the multi link device (for example, rows 14-20 of Table 7 may be link-specific per link of the multi link device). For example, the client wireless communication device 404-a may be the multi link device. Some fields shown in Table 7 may be multi link device specific and not per link (for example, rows 5-13 of Table 7 may be multi link device specific). In some examples, where the security context response message 414 includes a MLO client additional security context TLV in addition to the client security context TLV, the MLO client additional security context TLV may include VBSS client-specific fields associated with MLO operation as shown in Table 8, including the MLD_MAC_Addr field indicative of a MAC address of the MLD, the NUM_Affiliated field indicative of the quantity of affiliated links for the MLD, and link-specific fields such as the RUID field indicative of the radio unique identifier of the multi-AP agent, and/or the BSSID. For example, in Table 8, the fields in rows 9-12 may be provided per link of the multi link device (e.g., rows 9-12 may be link-specific per link of the multi link device). In Table 8, the fields in rows 5-8 may be multi link device specific (for example, not per link). The VBSS creation TLV in the VBSS request message 416 may include the VBSS client-specific fields and VBSS-specific fields associated with MLO operation as shown in Table 9. For example, the VBSS client-specific fields and the VBSS-specific fields shown in Table 9 may be provided to a target AP (for example, the second AP 402-b) and used to create or transfer an MLO client to a target AP. The VBSS-specific fields in Table 9 may include the fields/parameters above the row labeled “Client specific information,” and the VBSS client-specific fields in Table 9 may include the fields/parameters below the row labeled “Client specific information.” The parameters below the field “number of affiliated links” in Table 9 may be provided per link.

In some examples, for MLO, in addition to the one client info TLV and the one client security context TLV, the security context response message 414 may include one client operation report TLV and one TID-to-link mapping policy TLV. In some such examples, for MLO, in addition to the one extended VBSS creation TLV and the zero or one client capability report TLVs, the VBSS request message 416 may include the one client operation report TLV and one TID-to-link mapping policy TLV.

TABLE 7

| | Field | Length | Value | Description |
|---|---|---|---|---|
| 1 | tlvType | 1 octet | 0xDE | |
| 2 | tlvLength | 2 octets | Variable | Number of octets |
| | | | | in ensuing field. |
| 3 | tlvValue | | | |
| 4 | tlvSubType | 2 octets | 0x0005 | |
| 5 | Client Connected? | bit 7 | 0 or 1 | Indicates whether |
| | | | | client is connected |
| | | | | to network. If 1, |
| | | | | client is connected |
| | | | | to network. If 0, |
| | | | | client is not |
| | | | | connected or is in |
| | | | | the process of |
| | | | | connecting. |
| 6 | | bit 6-0 | 0 | Reserved |
| 7 | MLD_MAC_Addr | 6 octet | Variable | MAC Address of |
| | | | | multi link device |
| | | | | (MLD) |
| 8 | Key Length | 2 octets | Variable | Key Length in |
| | | | | octets-if the |
| | | | | network is open, |
| | | | | then this field is 0. |
| 9 | PTK | Variable | Variable | Pairwise Temporal |
| | | | | Key |
| 10 | Tx Packet Number | 8 octets | Unsigned | Tx Packet Number |
| | | | Integer | (TXPN) |
| 11 | PMK | Variable | Variable | Pairwise Master |
| | | | | Key |
| 12 | Rx Packet Number | 8 octets | Unsigned | Rx Packet Number |
| | | | Integer | (RXPN) |
| 13 | Num_Affiliated | 1 octet | Variable | Number of |
| | | | | affiliated links |
| 14 | RUID | 6 octets | Variable | Radio Unique |
| | | | | Identifier of a radio |
| | | | | of the Multi-AP |
| | | | | Agent. |
| 15 | BSSID | 6 octets | Variable | BSSID |
| 16 | Group Key Length | 2 octets | Unsigned | Group Key Length |
| | | | Integer | in octets |
| 17 | GTK | Variable | Variable | Group Temporal |
| | | | | Key |
| 18 | Group Tx Packet Num | 8 octets | Unsigned | Group Tx Packet |
| | | | Integer | Number |
| 19 | BIGTK | Variable | Variable | GTK for Beacon |
| | | | | protection, which |
| | | | | is mandatory for |
| | | | | 6G |
| 20 | I GTK | Variable | Variable | I GTK |
| | | | | The above 7 fields |
| | | | | (rows 14-20) are |
| | | | | present |
| | | | | Num_Affiliated |
| | | | | times. If |
| | | | | Num_Affiliated=0, |
| | | | | the above 7 fields |
| | | | | are omitted. |

TABLE 8

| | Field | Length | Value | Description |
|---|---|---|---|---|
| 1 | tlvType | 1 octet | 0xDE | |
| 2 | tlvLength | 2 octets | Variable | Number of octets in ensuing |
| | | | | field. |
| 3 | tlvValue | | | |
| 4 | tlvSubType | 2 octets | TBD | |
| 5 | MLD_MAC_Addr | 6 octet | Variable | MAC Address of MLD |
| 6 | PMK | Variable | Variable | Pairwise Master Key |
| 7 | Rx Packet Number | 8 octets | Unsigned Integer | Rx Packet Number (RXPN) |
| 8 | Num_Affiliated | 1 octet | Variable | Number of affiliated MAC address |
| 9 | RUID | 6 octets | Variable | Radio Unique Identifier of a radio of the |
| | | | | Multi-AP Agent. |
| 10 | BSSID | 6 octets | Variable | BSSID |
| 11 | BI GTK | Variable | Variable | GTK for Beacon protection, |
| | | | | which is mandatory for 6G |
| 12 | I GTK | Variable | Variable | I GTK |
| | | | | The above 4 fields are present |
| | | | | Num_Affiliated times. If |
| | | | | Num_Affiliated = 0, the above |

4 fields are omitted.

TABLE 9

| Field | Length | Value | Description |
|---|---|---|---|
| tlvType | 1 octet | 0xDE | |
| tlvLength | 2 octets | Unsigned Integer | Number of octets in ensuing field. |

tlvValue:

| | | | |
|---|---|---|---|
| tlvSubType | 2 octets | 0x0008 | |
| MLD_MAC_Addr | 6 octet | Variable | MAC Address of MLD |
| SSID Length | 2 octets | Unsigned Integer | SSID Length |
| SSID | Variable | String | SSID |
| Authentication | 2 octets | Unsigned Integer | Authentication Type from Table |
| Type | | | 32 of [3] |
| Pass Length | 2 octets | Unsigned Integer | Password/Passphrase Length-0 |
| | | | indicates that the WPA2 or SAE |
| | | | Pass is not present |
| Pass | Variable | String | WPA2 or SAE |
| | | | Passphrase/password |
| Encryption OUI | 3 octets | Octet Array | Any OUI value specified in Table |
| | | | 9-151 of [1] or Table 56 of [4]. |
| Encryption Suite | 2 octets | Unsigned Integer | Any suite type value specified in |
| Type | | | Table 9-151 of [1] or Table 56 of |
| | | | [4] |
| DPP Connector | 2 octets | Unsigned Integer | Length of DPP Connector String, 0 |
| Length | | | indicates that DPP Connector is |
| | | | not present |
| DPP Connector | Variable | String | DPP Connector string |
| Num_Affiliated | 1 octet | Variable | Number of affiliated MAC address |
| RUID | 6 octets | Variable | Radio Unique Identifier of a radio |
| | | | of the Multi-AP Agent. |
| BSSID | 6 octets | Variable | BSSID |
| | | | The above 2 fields are present |
| | | | Num_Affiliated times. If |
| | | | Num_Affiliated=0, the above 3 |
| | | | fields are omitted. |

Client specific information

| | | | |
|---|---|---|---|
| Client MLD MAC | 6 octets | Octet Array | Client's MLD MAC that this |
| | | | virtual BSS exists to serve. |
| Client Assoc | 1 octet | 0 or 1 | If 1, client is already associated, 0 |
| | | | if client is not yet associated. If |
| | | | this flag is 1 then the security |
| | | | context fields below are populated. |
| | | | If 0, then the security fields below |
| | | | are filled in with 0s. |

Security Context fields

| | | | |
|---|---|---|---|
| Key Length | 2 octets | Unsigned Integer | Key Length in octets |
| PTK | Variable | Variable | Pairwise Temporal Key |
| Tx Packet Num | 8 octets | Unsigned Integer | Tx Packet Number |
| Rx Packet Num | 8 octets | Unsigned Integer | Rx Packet Number (RXPN) |
| Num_Affiliated | 1 octet | Variable | Number of affiliated MAC address |
| Group Key Length | 2 octets | Unsigned Integer | Group Key Length in octets |
| GTK | Variable | Variable | Group Temporal Key |
| Group Tx Packet | 8 octets | Unsigned Integer | Group Tx Packet Number |
| Num | | | |
| | | | The above 3 fields are present |
| | | | Num_Affiliated times. If |
| | | | Num_Affiliated = 0, the above 3 |
| | | | fields are omitted. |

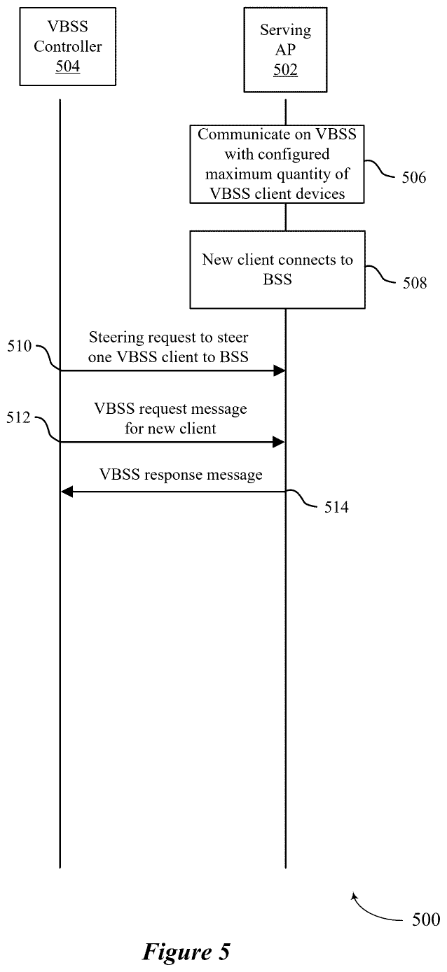

FIG. 5 shows an example of a process flow 500 associated with addition of a client wireless communication device to a VBSS in accordance with techniques for management of communication with the client wireless communication device in accordance with a VBSS. The process flow 500 may implement or may be implemented by aspects of the wireless communication network 100 or the signaling diagram 400. For example, the process flow 500 includes a serving AP 502, which may be an example of an AP 102 as described with reference to FIG. 1 or an AP 402 as described with reference to FIG. 4. As another example, the process flow 500 includes a VBSS controller 504, which may be an example of an AP 102 as described with reference to FIG. 1 or the third AP 402-c as described with reference to FIG. 4.

Alternative examples of the following may be implemented. Some operations may be performed in a different order than described or may not be performed at all. In some implementations, operations may include additional features not mentioned below, or further steps may be added. Further, although example devices are shown performing the operations of the process flow 500, some aspects of some operations also may be performed by one or more other wireless communication devices without exceeding the scope of the present disclosure.

In some embodiments, VBSS infrastructure within the Wi-Fi mesh network may have a limited quantity of available slots for client wireless communication devices. Once the slots are occupied, additional VBSS client(s) may not be admitted to the VBSS network, which may restrict the scalability of the quantity of VBSS client wireless communication devices that may be supported within a mesh network. In some examples, existing occupied VBSS slots may be reused by new client wireless communication devices. For new client wireless communication devices to re-use existing occupied slots, a slot may be freed up by steering or transitioning an existing VBSS client to a regular BSS VAP. The resulting newly available or “freed” slot may subsequently admit the new client wireless communication device via steering or transitioning the new client wireless communication device from the regular BSS VAP to the VBSS VAP.

For example, at 506, the serving AP 502 may communicate on the VBSS with a configured maximum quantity of VBSS client wireless communication devices. For example, the serving AP 502 may support up to N VBSS slots (where N is an integer), and all N VBSS slots may be occupied.

At 508, a new client wireless communication device may connect to the BSS of the serving AP 502. The new client wireless communication device may not be admitted to the VBSS initially as all available slots for the VBSS for the serving AP 502 are occupied.

At 510, the VBSS controller 504 may send a client steering request message to steer a first client wireless communication device of the client wireless communication devices connected to the VBSS to the regular BSS for the serving AP 502. For example, based on connection algorithms which may be based on relative signal strengths between the client wireless communication devices and the APs of the mesh network that includes the serving AP 502, the VBSS controller 504 may determine to move the new client wireless communication device to the VBSS and the first client wireless communication device from the VBSS to the regular BSS of the serving AP 502. The serving AP 502 may transition the first client wireless communication device from the VBSS to the regular BSS of the serving AP 502 based on the client steering request message, which may open a VBSS slot. In some examples, the criteria based on which client wireless communication device(s) should be swapped out of a VBSS slot may be mobility profiling or SLA requirements. For example, mobility profiling in a Wi-Fi mesh network may involve tracking and analyzing the movement patterns of client wireless communication devices, which may help distinguish between mobile client wireless communication devices, which frequently change locations, and static clients, which remain in fixed positions. By understanding these patterns, the mesh network may allocate VBSS slots more efficiently. Higher SLA requirements may ensure that premium clients, which demand prioritized traffic flows, are given precedence in occupying VBSS slots over regular clients. This prioritization may help maintain the quality of service for critical applications and ensures that premium clients experience optimal network performance.

At 512, the VBSS controller 504 may send a VBSS request message for the new client wireless communication device, the serving AP 502 may transition the new client wireless communication device to the VBSS (for example, from the regular BSS) based on the VBSS request message.

At 514, the serving AP 502 may send a VBSS response message that indicates that the serving AP 502 added the new client wireless communication device to the VBSS and/or that the serving AP 502 transitioned the first client wireless communication device to the regular BSS. In some examples, the first client wireless communication device may be moved from the VBSS to the regular BSS of the serving AP 502 via steering methods such as BSS transition management. In some examples, the new client wireless communication device may be moved to the VBSS via steering methods such as BSS transition management.

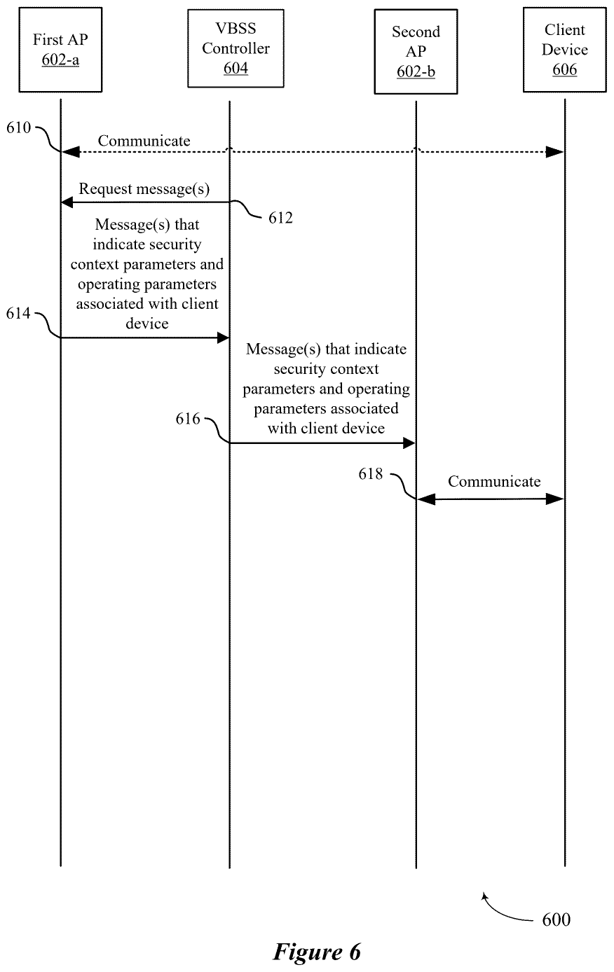

FIG. 6 shows an example of a process flow 600 associated with transfer of service from a first AP to a second AP that supports techniques for management of communication with a client wireless communication device in accordance with a VBSS. The process flow 600 may implement or may be implemented by aspects of the wireless communication network 100, the signaling diagram 400, or the process flow 600. For example, the process flow 600 includes a first AP 602-a and a second AP 602-b, which may be examples of an AP 102 as described with reference to FIG. 1, an AP 402 as described with reference to FIG. 4, or a serving AP 502 as described with reference to FIG. 5. As another example, the process flow 600 includes a first wireless communication device 604, which may be an example of an AP 102 as described with reference to FIG. 1, the third AP 402-c as described with reference to FIG. 4, or a VBSS controller 504 as described with reference to FIG. 5. As another example, the process flow 600 includes a client wireless communication device 606, which may be an example of an STA 104 as described reference to FIG. 1 or a client wireless communication device 404 as described with reference to FIG. 4.

Alternative examples of the following may be implemented. Some operations may be performed in a different order than described or may not be performed at all. In some implementations, operations may include additional features not mentioned below, or further steps may be added. Further, although example devices are shown performing the operations of the process flow 600, some aspects of some operations also may be performed by one or more other wireless communication devices without exceeding the scope of the present disclosure.

In some examples, at 610, the first AP 602-a may communicate with the client wireless communication device 606 via a wireless communication link (such as the communication link 408-a of FIG. 4).

At 612, the first AP 602-a may receive, from the first wireless communication device 604, one or more request messages associated with transfer of service for the client wireless communication device 606 from the first AP 602-a to the second AP 602-b in accordance with a VBSS. The first wireless communication device 604 may be a controller of the VBSS. The VBSS may be associated with the first AP 602-a and the second AP 602-b.

At 614, the first AP 602-a may transmit, to the first wireless communication device 604, one or more first messages that indicate a set of security context parameters associated with the client wireless communication device 606 and a set of operating parameters associated with the client wireless communication device 606.

At 616, the first wireless communication device 604 may transmit, to the second AP 602-b, in association with the one or more first messages, one or more second messages that indicate the set of security context parameters and the set of operating parameters.

At 618, the second AP 602-b may communicate with the client wireless communication device 606 in accordance with the VBSS in association with the one or more messages.

In some examples, the one or more request messages at 612 may include a client security context request message, and the one or more first messages at 614 may include a client security context response message in response to the client security context request message, where the client security context response message includes the set of security context parameters. In some examples, the client security context response message includes a client security context IE that includes a BIGTK parameter, an IGTK, a PMK parameter, a receiver packet number parameter, or a combination thereof. In some examples, the one or more second messages at 616 may include a VBSS request message that includes an extended VBSS IE, the extended VBSS IE including the BI GTK parameter, the IGTK, the PMK parameter, the receiver packet number parameter, or the combination thereof, the one or more second messages including the VBSS request message. In some examples, the client security context response message includes a client security context IE and a client additional security context IE, the client additional security context IE including a BI GTK parameter, an IGTK, a PMK parameter, a receiver packet number parameter, or a combination thereof. In some examples, the one or more second messages at 616 may include a VBSS request message that includes an extended VBSS IE and the client additional security context IE.

In some examples, the one or more first messages include a client operation report IE associated with the set of operating parameters, the client operation report IE including a receiver NSS type parameter, a receiver NSS parameter, a LDPC encoding parameter, a channel width parameter, a SMPS parameter, one or more individual TWT parameters, one or more broadcast TWT parameters, or a combination thereof. In some examples, the one or more second messages at 616 may include a VBSS request message that includes the client operation report IE.

In some examples, the one or more first messages include a set of VBSS client-specific MLO parameters associated with the client wireless communication device 606, the set of VBSS client-specific MLO parameters including a multi link device MAC address parameter and one or more link-specific parameters associated with each link of the multi link device. For example, the set of VBSS client-specific MLO parameters may include the one or more of the parameters in Tables 7 or 8 as described herein. For example, the one or more link-specific parameters associated with each link of the multi link device may include the fields in rows 14-20 of Table 7 (and the multi link device MAC address may correspond to the MLD_MAC_Addr field of Table 7) and/or the one or more link-specific parameters associated with each link of the multi link device may include the fields in rows 9-12 of Table 8 (and the multi link device MAC address may correspond to the MLD_MAC_Addr field of Table 8). Other non-link-specific multi link device specific parameters of Tables 7 and/or 8 may be included in the set of VBSS client-specific MLO parameters included in the one or more first messages. A non-link specific multi link device specific parameter may refer to a parameter associated with operation of the MLO for the multi link device that is not provided per-link of the multi link device. In some examples, the first wireless communication device 604 may transmit, to the second AP 602-b, a VBSS request message that includes a set of VBSS-specific MLO parameters, the set of VBSS-specific MLO parameters including a multi link device MAC address parameter (for example, the multi link device MAC address may correspond to the MLD_MAC_Addr field of Table 9) and one or more first link-specific parameters associated with each link of the multi link device (for example, the RUID and/or the BSSID fields of Table 9). Other non-link multi link device specific parameters of Table 9 may be included in the set of VBSS-specific MLO parameters included in the VBSS request message (for example, the other parameters above the row labeled “Client specific information” in Table 9). The VBSS request message may further include a set of VBSS client-specific MLO parameters including a client multi link device MAC address parameter (for example, the Client_MLD_MAC field of Table 9) and one or more second link-specific parameters associated with each link of the multi link device (for example, the other parameters below the row labeled “Client specific information” in Table 9).

In some examples, the one or more first messages include a T2L mapping policy IE associated with a set of MLO parameters associated with the client wireless communication device. In some examples, the one or more second messages at 616 may include a VBSS request message that includes the T2L mapping policy IE.

In some examples, the first wireless communication device 604 may transition, in association with addition of the client wireless communication device 606 to the VBSS, a second client wireless communication device from the VBSS to a BSS associated with an AP associated with the VBSS. In some such examples, the first wireless communication device 604 may add the client wireless communication device 606 to the VBSS after the transitioning, reception of the one or more first messages at 614 being in association with the addition of the client wireless communication device to the VBSS. For example, the first wireless communication device 604 may transmit a control message to an AP associated with the VBSS that indicates to transition the second client wireless communication device from the VBSS to a BSS associated with the AP. In some examples, the transitioning the second client wireless communication device (e.g., transmitting the control message) from the VBSS to the BSS may be in association with the addition of the client wireless communication device 606 to the VBSS exceeding a maximum quantity of client wireless communication devices for the VBSS. In some examples, the transitioning the second client wireless communication device (for example, transmitting the control message) from the VBSS to the BSS may be in association with a first mobility profile associated with the client wireless communication device 606, a second mobility profile associated with the second client wireless communication device, respective SLA priorities associated with the client wireless communication device 606 and the second client wireless communication device, or any combination thereof.

In some examples, the first wireless communication device 604 may receive, from the first AP 602-a, a first indication of a first signal strength associated with a first link between the first AP 602-a and the client wireless communication device 606. In some such examples, the first wireless communication device 604 may receive, from the second AP 602-b, a second indication of a second signal strength associated with a second link between the second AP 602-b and the client wireless communication device 606, the transfer of service associated with the second signal strength being stronger than the first signal strength. For example, the transfer or service may be associated with the second signal strength being better by a threshold than the first signal strength.

In some examples, the first wireless communication device 604 may be a controller of the VBSS.

In some examples, the first AP 602-a may terminate, in association with transmission of the one or more first messages, communication with the client wireless communication device 606 in accordance with a basic service set. For example, the first AP 602-a may communicate with the client wireless communication device 606 at 610 in accordance with the BSS.

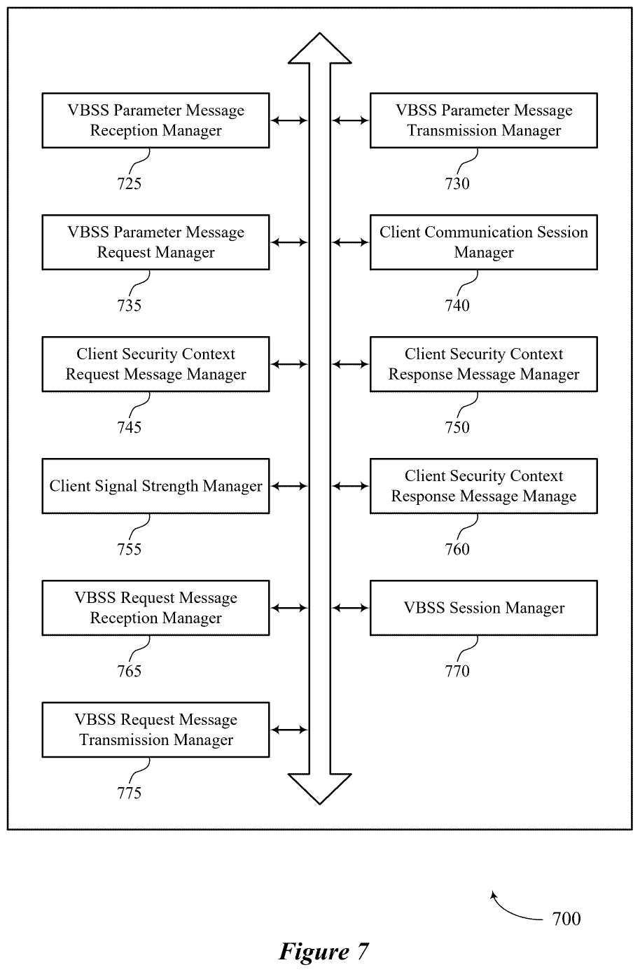

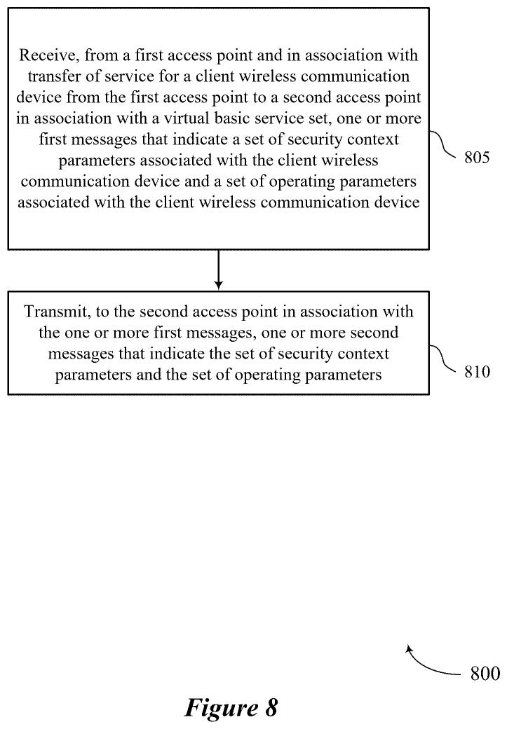

FIG. 7 shows a block diagram of an example wireless communication device 700 that supports techniques for management of communication with a client wireless communication device in accordance with a VBSS. In some examples, the wireless communication device 700 is configured to perform the processes 800, 900, and 1000 described with reference to FIGS. 8, 9, and 10, respectively. For example, the wireless communication device 700 may be an example of an AP 102 as described with reference to FIG. 1, an AP 402 as described with reference to FIG. 4, a serving AP 502 or a VBSS controller 504 as described with reference to FIG. 5, or an AP 602 or a first wireless communication device 604 as described with reference to FIG. 6.

The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP, such as the AP 102 described with reference to FIG. 1. In some other examples, the wireless communication device 700 can be an AP that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes at least one external network interface coupled with the processing system that enables communication with a core network or backhaul network that enables the wireless communication device 700 to gain access to external networks including the Internet.

The wireless communication device 700 includes an VBSS parameter message reception manager 725, an VBSS parameter message transmission manager 730, an VBSS parameter message request manager 735, a client communication session manager 740, a client security context request message manager 745, a client security context response message manager 750, a client signal strength manager 755, a client security context response message manage 760, an VBSS request message reception manager 765, an VBSS session manager 770, and an VBSS request message transmission manager 775. Portions of one or more of the VBSS parameter message reception manager 725, the VBSS parameter message transmission manager 730, the VBSS parameter message request manager 735, the client communication session manager 740, the client security context request message manager 745, the client security context response message manager 750, the client signal strength manager 755, the client security context response message manage 760, the VBSS request message reception manager 765, the VBSS session manager 770, and the VBSS request message transmission manager 775 may be implemented at least in part in hardware or firmware. For example, one or more of the VBSS parameter message reception manager 725, the VBSS parameter message transmission manager 730, the VBSS parameter message request manager 735, the client communication session manager 740, the client security context request message manager 745, the client security context response message manager 750, the client signal strength manager 755, the client security context response message manage 760, the VBSS request message reception manager 765, the VBSS session manager 770, and the VBSS request message transmission manager 775 may be implemented at least in part by at least a processor or a modem. In some examples, portions of one or more of the VBSS parameter message reception manager 725, the VBSS parameter message transmission manager 730, the VBSS parameter message request manager 735, the client communication session manager 740, the client security context request message manager 745, the client security context response message manager 750, the client signal strength manager 755, the client security context response message manage 760, the VBSS request message reception manager 765, the VBSS session manager 770, and the VBSS request message transmission manager 775 may be implemented at least in part by a processor and software in the form of processor-executable code stored in memory.

The wireless communication device 700 may support wireless communications in accordance with examples as disclosed herein. The VBSS parameter message reception manager 725 is configurable or configured to receive, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device. The VBSS parameter message transmission manager 730 is configurable or configured to transmit, to the second AP in association with the one or more first messages, one or more second messages that indicate the set of security context parameters and the set of operating parameters.

In some examples, the client security context request message manager 745 is configurable or configured to transmit, to the first AP, a client security context request message. In some examples, the client security context response message manager 750 is configurable or configured to receive, from the first AP and in response to the client security context request message, a client security context response message that includes the set of security context parameters, the one or more first messages including the client security context response message.

In some examples, the client security context response message includes a client security context IE that includes a BI GTK parameter, an IGTK, a PMK parameter, a receiver packet number parameter, or a combination thereof.

In some examples, the VBSS request message transmission manager 775 is configurable or configured to transmit, to the second AP, a VBSS request message that includes an extended VBSS IE, the extended VBSS IE including the BI GTK parameter, the IGTK, the PMK parameter, the receiver packet number parameter, or the combination thereof, the one or more second messages including the VBSS request message.

In some examples, the client security context response message includes a client security context IE and a client additional security context IE, the client additional security context IE including a BI GTK parameter, an IGTK, a PMK parameter, a receiver packet number parameter, or a combination thereof.

In some examples, the VBSS request message transmission manager 775 is configurable or configured to transmit, to the second AP, a VBSS request message that includes an extended VBSS IE and the client additional security context IE.

In some examples, the one or more first messages include a client operation report IE associated with the set of operating parameters, the client operation report IE including a receiver NSS type parameter, a receiver NSS parameter, a LDPC encoding parameter, a channel width parameter, a SMPS parameter, one or more individual TWT parameters, one or more broadcast TWT parameters, or a combination thereof.

In some examples, the VBSS request message transmission manager 775 is configurable or configured to transmit, to the second AP, a VBSS request message that includes the client operation report IE, the one or more second messages including the VBSS request message.

In some examples, the one or more first messages include a set of VBSS client-specific MLO parameters associated with the client wireless communication device, the set of VBSS client-specific MLO parameters including a multi link device MAC address parameter and one or more link-specific parameters associated with each link of a multi link device, the client wireless communication device being the multi link device. In some examples, the VBSS request message transmission manager 775 is configurable or configured to transmit, to the second AP, a VBSS request message that includes a set of VBSS-specific MLO parameters, the set of VBSS-specific multi link operation parameters including a multi link device MAC address parameter and one or more first link-specific parameters associated with each link of a multi link device, the client wireless communication device being the multi link device, the VBSS request message further including a set of VBSS client-specific MLO parameters including a client multi link device MAC address parameter and one or more second link-specific parameters associated with each link of the multi link device.

In some examples, the one or more first messages include a T2L mapping policy IE associated with a set of MLO parameters associated with the client wireless communication device.

In some examples, the VBSS request message transmission manager 775 is configurable or configured to transmit, to the second AP, a VBSS request message that includes the T2L mapping policy IEs, the one or more second messages including the VBSS request message.

In some examples, the VBSS session manager 770 is configurable or configured to transmit, in association with addition of the client wireless communication device to the VBSS, a control message to an AP associated with the VBSS that indicates to transition a second client wireless communication device from the VBSS to a BSS associated with the AP, reception of the one or more first messages being in association with the addition of the client wireless communication device to the VBSS.

In some examples, transmitting the control message is in association with the addition of the client wireless communication device to the VBSS exceeding a maximum quantity of client wireless communication devices for the VBSS.

In some examples, the transmitting the control message is in association with a first mobility profile associated with the client wireless communication device, a second mobility profile associated with the second client wireless communication device, respective SLA priorities associated with the client wireless communication device and the second client wireless communication device, or any combination thereof.

In some examples, the client signal strength manager 755 is configurable or configured to receive, from the first AP, a first indication of a first signal strength associated with a first link between the first AP and the client wireless communication device. In some examples, the client signal strength manager 755 is configurable or configured to receive, from the second AP, a second indication of a second signal strength associated with a second link between the second AP and the client wireless communication device, the transfer of service associated with the second signal strength being stronger than the first signal strength.

In some examples, the first wireless communication device may be a controller of the VBSS.

Additionally, or alternatively, the wireless communication device 700 may support wireless communications in accordance with examples as disclosed herein. The VBSS parameter message request manager 735 is configurable or configured to receive, from a first wireless communication device, one or more request messages associated with transfer of service for a client wireless communication device from the first AP to a second AP in accordance with a VBSS, the VBSS associated with the first AP and the second AP. In some examples, the VBSS parameter message transmission manager 730 is configurable or configured to transmit, to the first wireless communication device, one or more first messages that indicate a set of security context parameters associated with the client wireless communication device and a set of operating parameters associated with the client wireless communication device.

In some examples, the client security context request message manager 745 is configurable or configured to receive, from the first wireless communication device, a client security context request message, the one or more request messages including the client security context request message. In some examples, the client security context response message manage 760 is configurable or configured to transmit, to the first wireless communication device in association with the client security context request message, a client security context response message that includes the set of security context parameters, the one or more first messages including the client security context response message.

In some examples, the client security context response message includes a client security context IE that includes a BI GTK parameter, an IGTK, a PMK parameter, a receiver packet number parameter, or a combination thereof.

In some examples, the client security context response message includes a client security context IE and a client additional security context IE, the client additional security context IE including a BI GTK parameter, an IGTK, a PMK parameter, a receiver packet number parameter, or a combination thereof.

In some examples, the one or more first messages include a client operation report IE associated with the set of operating parameters, the client operation report IE including a receiver NSS type parameter, a receiver NSS parameter, a LDPC encoding parameter, a channel width parameter, a SMPS parameter, one or more individual TWT parameters, one or more broadcast TWT parameters, or a combination thereof.

In some examples, the one or more first messages include a set of VBSS client-specific MLO parameters associated with the client wireless communication device, the set of VBSS client-specific MLO parameters including a multi link device MAC address parameter and one or more link-specific parameters associated with each link of a multi link device, the client wireless communication device being the multi link device.

In some examples, the one or more first messages include a T2L mapping policy IE associated with a set of MLO parameters associated with the client wireless communication device.

In some examples, the client communication session manager 740 is configurable or configured to terminate, in association with transmission of the one or more first messages, communication with the client wireless communication device in accordance with a BSS.

In some examples, the client signal strength manager 755 is configurable or configured to transmit, to the first wireless communication device, an indication of a signal strength associated with a first link between the first AP and the client wireless communication device, where the transfer of service to the second AP is in association with the indication.

Additionally, or alternatively, the wireless communication device 700 may support wireless communications in accordance with examples as disclosed herein. In some examples, the VBSS parameter message reception manager 725 is configurable or configured to receive, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device. The client communication session manager 740 is configurable or configured to communicate with the client wireless communication device in accordance with the VBSS in association with the one or more messages.

In some examples, the VBSS request message reception manager 765 is configurable or configured to receive, from the first wireless communication device, a VBSS request message that includes an extended VBSS IE, the extended VBSS IE including a BI GTK parameter, an IGTK, a PMK parameter, a receiver packet number parameter, or a combination thereof, the one or more messages including the VBSS request message.

In some examples, the VBSS request message reception manager 765 is configurable or configured to receive, from the first wireless communication device, a VBSS request message that includes a client security context IE and a client additional security context IE, the client additional security context IE including a BI GTK parameter, an IGTK, a PMK parameter, a receiver packet number parameter, or a combination thereof, the one or more messages including the VBSS request message.

In some examples, the VBSS request message reception manager 765 is configurable or configured to receive, from the first wireless communication device, a VBSS request message that includes a client operation report IE associated with the set of operating parameters, the client operation report IE including a receiver NSS type parameter, a receiver NSS parameter, a LDPC encoding parameter, a channel width parameter, a SMPS parameter, one or more individual TWT parameters, one or more broadcast TWT parameters, or a combination thereof, the one or more messages including the VBSS request message.

In some examples, the VBSS request message reception manager 765 is configurable or configured to receive, from the first wireless communication device, a VBSS request message that includes an extended VBSS IE, the extended VBSS IE including a BI GTK parameter, an IGTK parameter, a PMK parameter, a receiver packet number parameter, or a combination thereof, the one or more messages including the VBSS request message.

In some examples, the VBSS request message reception manager 765 is configurable or configured to receive, from the first wireless communication device, a VBSS request message that includes a set of VBSS-specific MLO parameters, the set of VBSS-specific MLO parameters including a multi link device MAC address parameter and one or more first link-specific parameters associated with each link of a multi link device, the client wireless communication device being the multi link device, the VBSS request message further including a set of VBSS client-specific MLO parameters including a client multi link device MAC address parameter and one or more second link-specific parameters associated with each link of the multi link device.

In some examples, the VBSS request message reception manager 765 is configurable or configured to receive, from the first wireless communication device, a VBSS request message that includes a T2L mapping policy IE associated with a set of MLO parameters associated with the client wireless communication device, the one or more messages including the VBSS request message.

In some examples, the client signal strength manager 755 is configurable or configured to transmit, to the first wireless communication device, an indication of a signal strength associated with a first link between the second AP and the client wireless communication device, where the transfer of service to the second AP is in association with the indication.

FIG. 8 shows a flowchart illustrating an example process 800 performable by or at a first wireless communication device that supports techniques for management of communication with a client wireless communication device in accordance with a VBSS. The operations of the process 800 may be implemented by a first wireless communication device or its components as described herein. For example, the process 800 may be performed by a wireless communication device, such as the wireless communication device 700 described with reference to FIG. 7, operating as or within a wireless AP. In some examples, the process 800 may be performed by a wireless AP, such as one of the APs 102 described with reference to FIG. 1.

In some examples, in 805, the first wireless communication device may receive, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device. The operations of 805 may be performed in accordance with examples as disclosed herein. In some implementations, aspects of the operations of 805 may be performed by an VBSS parameter message reception manager 725 as described with reference to FIG. 7.

In some examples, in 810, the first wireless communication device may transmit, to the second AP in association with the one or more first messages, one or more second messages that indicate the set of security context parameters and the set of operating parameters. The operations of 810 may be performed in accordance with examples as disclosed herein. In some implementations, aspects of the operations of 810 may be performed by an VBSS parameter message transmission manager 730 as described with reference to FIG. 7.

FIG. 9 shows a flowchart illustrating an example process 900 performable by or at a first AP that supports techniques for management of communication with a client wireless communication device in accordance with a VBSS. The operations of the process 900 may be implemented by a first AP or its components as described herein. For example, the process 900 may be performed by a wireless communication device, such as the wireless communication device 700 described with reference to FIG. 7, operating as or within a wireless AP. In some examples, the process 900 may be performed by a wireless AP, such as one of the APs 102 described with reference to FIG. 1.

In some examples, in 905, the first AP may receive, from a first wireless communication device, one or more request messages associated with transfer of service for a client wireless communication device from the first AP to a second AP in accordance with a VBSS, the VBSS associated with the first AP and the second AP. The operations of 905 may be performed in accordance with examples as disclosed herein. In some implementations, aspects of the operations of 905 may be performed by an VBSS parameter message request manager 735 as described with reference to FIG. 7.

In some examples, in 910, the first AP may transmit, to the first wireless communication device, one or more first messages that indicate a set of security context parameters associated with the client wireless communication device and a set of operating parameters associated with the client wireless communication device. The operations of 910 may be performed in accordance with examples as disclosed herein. In some implementations, aspects of the operations of 910 may be performed by an VBSS parameter message transmission manager 730 as described with reference to FIG. 7.

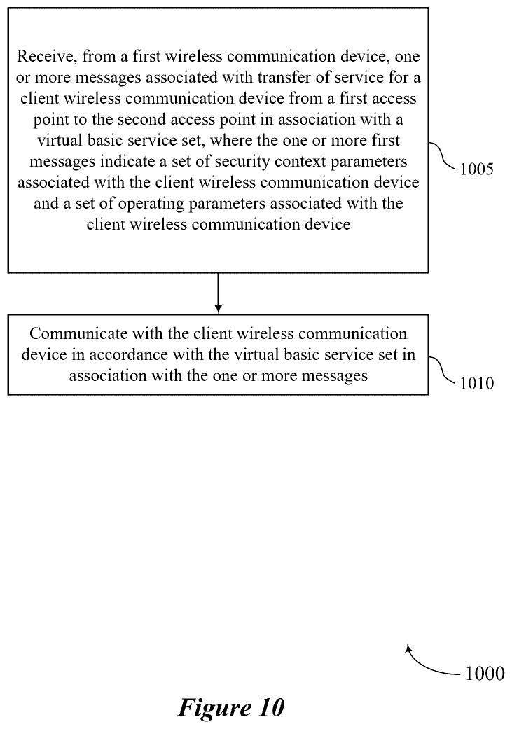

FIG. 10 shows a flowchart illustrating an example process 1000 performable by or at a second AP that supports techniques for management of communication with a client wireless communication device in accordance with a VBSS. The operations of the process 1000 may be implemented by a second AP or its components as described herein. For example, the process 1000 may be performed by a wireless communication device, such as the wireless communication device 700 described with reference to FIG. 7, operating as or within a wireless AP. In some examples, the process 1000 may be performed by a wireless AP, such as one of the APs 102 described with reference to FIG. 1.

In some examples, in 1005, the second AP may receive, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device. The operations of 1005 may be performed in accordance with examples as disclosed herein. In some implementations, aspects of the operations of 1005 may be performed by an VBSS parameter message reception manager 725 as described with reference to FIG. 7.

In some examples, in 1010, the second AP may communicate with the client wireless communication device in accordance with the VBSS in association with the one or more messages. The operations of 1010 may be performed in accordance with examples as disclosed herein. In some implementations, aspects of the operations of 1010 may be performed by a client communication session manager 740 as described with reference to FIG. 7.

Implementation examples are described in the following numbered clauses:
Aspect 1: A method for wireless communications at a first wireless communication device, including: receiving, from a first AP and in association with transfer of service for a client wireless communication device from the first AP to a second AP in association with a VBSS, one or more first messages that indicate a set of security context parameters associated with the client wireless communication device and a set of operating parameters associated with the client wireless communication device; and transmitting, to the second AP in association with the one or more first messages, one or more second messages that indicate the set of security context parameters and the set of operating parameters.
Aspect 2: The method of aspect 1, further including: transmitting, to the first AP, a client security context request message; and receiving, from the first AP and in response to the client security context request message, a client security context response message that includes the set of security context parameters, the one or more first messages including the client security context response message.
Aspect 3: The method of aspect 2, where the client security context response message includes a client security context IE that includes a BI GTK parameter, an IGTK parameter, a PMK parameter, a receiver packet number parameter, or a combination thereof.
Aspect 4: The method of aspect 3, further including: transmitting, to the second AP, a VBSS request message that includes an extended VBSS IE, the extended VBSS IE including the BI GTK parameter, the IGTK parameter, the PMK parameter, the receiver packet number parameter, or the combination thereof, the one or more second messages including the VBSS request message.
Aspect 5: The method of any of aspects 2-4, where the client security context response message includes a client security context IE and a client additional security context IE, the client additional security context IE including a BI GTK parameter, an IGTK parameter, a PMK parameter, a receiver packet number parameter, or a combination thereof.
Aspect 6: The method of aspect 5, further including: transmitting, to the second AP, a VBSS request message that includes an extended VBSS IE and the client additional security context IE.
Aspect 7: The method of any of aspects 1-6, where the one or more first messages include a client operation report IE associated with the set of operating parameters, the client operation report IE including a receiver NSS type parameter, a receiver NSS parameter, a LDPC encoding parameter, a channel width parameter, a spatial multiplexing power saving parameter, one or more individual TWT parameters, one or more broadcast TWT parameters, or a combination thereof.
Aspect 8: The method of aspect 7, further including: transmitting, to the second AP, a VBSS request message that includes the client operation report IE, the one or more second messages including the VBSS request message.
Aspect 9: The method of any of aspects 1-8, where the one or more first messages include a set of VBSS client-specific MLO parameters associated with the client wireless communication device, the set of VBSS client-specific MLO parameters including a multi link device MAC address parameter, and one or more link-specific parameters associated with each link of the multi link device, the client wireless communication device being the multi link device.
Aspect 10: The method of aspect 9, further including: transmitting, to the second AP, a VBSS request message that comprises a set of VBSS-specific MLO parameters, the set of VBSS-specific MLO parameters comprising a multi link device MAC address parameter and one or more first link-specific parameters associated with each link of a multi link device, the virtual basic service set request message further comprising a set of VBSS client-specific MLO parameters comprising a client multi link device MAC address parameter and one or more second link-specific parameters associated with each link of the multi link device, the client wireless communication device being the multi link device.
Aspect 11: The method of any of aspects 1-10, where the one or more first messages include a traffic identifier to link mapping policy IEs associated with a set of MLO parameters associated with the client wireless communication device.
Aspect 12: The method of aspect 11, further including: transmitting, to the second AP, a VBSS request message that includes the traffic identifier to link mapping policy IEs, the one or more second messages including the VBSS request message.
Aspect 13: The method of any of aspects 1-12, further including: transmitting, in association with addition of the client wireless communication device to the VBSS, a control message to an AP associated with the VBSS that indicates to transition a second client wireless communication device from the VBSS to a BSS associated with the AP, reception of the one or more first messages being in association with the addition of the client wireless communication device to the VBSS.
Aspect 14: The method of aspect 13, where transmitting the control message is in association with the addition of the client wireless communication device to the VBSS exceeding a maximum quantity of client wireless communication devices for the VBSS.
Aspect 15: The method of any of aspects 13-14, where transmitting the control message is in association with a first mobility profile associated with the client wireless communication device, a second mobility profile associated with the second client wireless communication device, respective SLA priorities associated with the client wireless communication device and the second client wireless communication device, or any combination thereof.
Aspect 16: The method of any of aspects 1-15, further including: receiving, from the first AP, a first indication of a first signal strength associated with a first link between the first AP and the client wireless communication device; and receiving, from the second AP, a second indication of a second signal strength associated with a second link between the second AP and the client wireless communication device, the transfer of service associated with the second signal strength being stronger than the first signal strength.
Aspect 17: The method of any of aspects 1-16, where the first wireless communication device is a controller of the VBSS.
Aspect 18: A method for wireless communications at a first AP, including: receiving, from a first wireless communication device, one or more request messages associated with transfer of service for a client wireless communication device from the first AP to a second AP in accordance with a VBSS, the VBSS associated with the first AP and the second AP; and transmitting, to the first wireless communication device, one or more first messages that indicate a set of security context parameters associated with the client wireless communication device and a set of operating parameters associated with the client wireless communication device.
Aspect 19: The method of aspect 18, further including: receiving, from the first wireless communication device, a client security context request message, the one or more request messages including the client security context request message; and transmitting, to the first wireless communication device in association with the client security context request message, a client security context response message that includes the set of security context parameters, the one or more first messages including the client security context response message.
Aspect 20: The method of aspect 19, where the client security context response message includes a client security context IE that includes a BI GTK parameter, an IGTK parameter, a PMK parameter, a receiver packet number parameter, or a combination thereof.
Aspect 21: The method of any of aspects 19-20, where the client security context response message includes a client security context IEand a client additional security context IE, the client additional security context IE including a BI GTK parameter, an IGTK parameter, a PMK parameter, a receiver packet number parameter, or a combination thereof.
Aspect 22: The method of any of aspects 19-21, where the one or more first messages include a client operation report IE associated with the set of operating parameters, the client operation report IE including a receiver NSS type parameter, a receiver NSS parameter, a LDPC encoding parameter, a channel width parameter, a spatial multiplexing power saving parameter, one or more individual TWT parameters, one or more broadcast TWT parameters, or a combination thereof.
Aspect 23: The method of any of aspects 19-22, where the one or more first messages include a set of VBSS client-specific MLO parameters associated with the client wireless communication device, the set of VBSS-specific MLO parameters including a multi link device MAC address parameter, and one or more link-specific parameters associated with each link of the multi link device, the client wireless communication device being the multi link device.
Aspect 24: The method of any of aspects 19-23, where the one or more first messages include a traffic identifier to link mapping policy IE associated with a set of MLO parameters associated with the client wireless communication device.
Aspect 25: The method of any of aspects 18-24, further including: terminating, in association with transmission of the one or more first messages, communication with the client wireless communication device in accordance with a BSS.
Aspect 26: The method of any of aspects 18-25, further including: transmitting, to the first wireless communication device, an indication of a signal strength associated with a first link between the first AP and the client wireless communication device, where the transfer of service to the second AP is in association with the indication.
Aspect 27: The method of any of aspects 18-26, where the first wireless communication device is a controller of the VBSS.
Aspect 28: A method for wireless communications at a second AP, including: receiving, from a first wireless communication device, one or more messages associated with transfer of service for a client wireless communication device from a first AP to the second AP in association with a VBSS, where the one or more messages indicate a set of security context parameters associated with the client wireless communication device and a set of operating parameters associated with the client wireless communication device; and communicating with the client wireless communication device in accordance with the VBSS in association with the one or more messages.
Aspect 29: The method of aspect 28, further including: receiving, from the first wireless communication device, a VBSS request message that includes an extended VBSS IE, the extended VBSS IE including a BI GTK parameter, an IGTK parameter, a PMK parameter, a receiver packet number parameter, or a combination thereof, the one or more messages including the VBSS request message.
Aspect 30: The method of any of aspects 28-29, further including: receiving, from the first wireless communication device, a VBSS request message that includes a client security context IEand a client additional security context IE, the client additional security context IE including a BI GTK parameter, an IGTK parameter, a PMK parameter, a receiver packet number parameter, or a combination thereof, the one or more messages including the VBSS request message.
Aspect 31: The method of any of aspects 28-30, further including: receiving, from the first wireless communication device, a VBSS request message that includes a client operation report IE associated with the set of operating parameters, the client operation report IE including a receiver NSS type parameter, a receiver NSS parameter, a LDPC encoding parameter, a channel width parameter, a spatial multiplexing power saving parameter, one or more individual TWT parameters, one or more broadcast TWT parameters, or a combination thereof, the one or more messages including the VBSS request message.
Aspect 32: The method of any of aspects 28-31, further including: receiving, from the first wireless communication device, a VBSS request message that comprises a set of VBSS-specific MLO parameters, the set of VBSS-specific MLO parameters comprising a multi link device MAC address parameter and one or more first link-specific parameters associated with each link of a multi link device, the virtual basic service set request message further comprising a set of VBSS client-specific MLO parameters comprising a client multi link device MAC address parameter and one or more second link-specific parameters associated with each link of the multi link device, the client wireless communication device being the multi link device.
Aspect 33: The method of any of aspects 28-32, further including: receiving, from the first wireless communication device, a VBSS request message that includes a traffic identifier to link mapping policy IE associated with a set of MLO parameters associated with the client wireless communication device, the one or more messages including the VBSS request message.
Aspect 34: The method of any of aspects 28-33, further including: transmitting, to the first wireless communication device, an indication of a signal strength associated with a first link between the second AP and the client wireless communication device, where the transfer of service to the second AP is in association with the indication.
Aspect 35: The method of any of aspects 28-34, where the first wireless communication device is a controller of the VBSS.
Aspect 36: A first wireless communication device, including: a processing system that includes processor circuitry and memory circuitry that stores code, the processing system configured to cause the first wireless communication device to perform a method of any of aspects 1-17.
Aspect 37: A first wireless communication device for wireless communications, including at least one means for performing a method of any of aspects 1-17.
Aspect 38: A non-transitory computer-readable medium storing code for wireless communications, the code including instructions executable by one or more processors to perform a method of any of aspects 1-17.
Aspect 39: A first AP, including: a processing system that includes processor circuitry and memory circuitry that stores code, the processing system configured to cause the first AP to perform a method of any of aspects 18-27.
Aspect 40: A first AP for wireless communications, including at least one means for performing a method of any of aspects 18-27.
Aspect 41: A non-transitory computer-readable medium storing code for wireless communications, the code including instructions executable by one or more processors to perform a method of any of aspects 18-27.
Aspect 42: A second AP, including: a processing system that includes processor circuitry and memory circuitry that stores code, the processing system configured to cause the second AP to perform a method of any of aspects 28-35.
Aspect 43: A second AP for wireless communications, including at least one means for performing a method of any of aspects 28-35.
Aspect 44: A non-transitory computer-readable medium storing code for wireless communications, the code including instructions executable by one or more processors to perform a method of any of aspects 28-35.

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

In some implementations, one or more of the multiple memories may be configured to store processor-executable code that, when executed, may configure one or more of the multiple processors to perform various functions described herein (as part of a processing system). In some other implementations, the processing system may be pre-configured to perform various functions described herein.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrases “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
receive, from a first access point and in association with transfer of service for a client wireless communication device from the first access point to a second access point in association with a virtual basic service set:
one or more first messages that indicate a set of security context parameters associated with the client wireless communication device and
a set of operating parameters associated with the client wireless communication device; and
transmit, to the second access point in association with the one or more first messages, one or more second messages that indicate the set of security context parameters and the set of operating parameters.

2. The first wireless communication device of claim 1, wherein the processing system is further configured to cause the first wireless communication device to:
transmit, to the first access point, a client security context request message; and
receive, from the first access point and in response to the client security context request message, a client security context response message that includes the set of security context parameters, wherein the one or more first messages include the client security context response message.

3. The first wireless communication device of claim 2, wherein the client security context response message comprises a client security context information element that comprises a beacon interval group temporal key parameter, an integrity group temporal key, a pairwise master key parameter, a receiver packet number parameter, or a combination thereof.

4. The first wireless communication device of claim 3, wherein the processing system is further configured to cause the first wireless communication device to transmit, to the second access point, a virtual basic service set request message that comprises an extended virtual basic service set information element, the extended virtual basic service set information element comprising the beacon interval group temporal key parameter, the integrity group temporal key, the pairwise master key parameter, the receiver packet number parameter, or the combination thereof, the one or more second messages comprising the virtual basic service set request message.

5. The first wireless communication device of claim 2, wherein the client security context response message comprises a client security context information element and a client additional security context information element, the client additional security context information element comprising a beacon interval group temporal key parameter, an integrity group temporal key, a pairwise master key parameter, a receiver packet number parameter, or a combination thereof.

6. The first wireless communication device of claim 5, wherein the processing system is further configured to cause the first wireless communication device to transmit, to the second access point, a virtual basic service set request message that comprises an extended virtual basic service set information element and the client additional security context information element.

7. The first wireless communication device of claim 1, wherein the one or more first messages comprise a client operation report information element associated with the set of operating parameters, the client operation report information element comprising a receiver number of spatial streams type parameter, a receiver number of spatial streams parameter, a low density parity check encoding parameter, a channel width parameter, a spatial multiplexing power saving parameter, one or more individual target wake time parameters, one or more broadcast target wake time parameters, or a combination thereof.

8. The first wireless communication device of claim 7, wherein the processing system is further configured to cause the first wireless communication device to transmit, to the second access point, a virtual basic service set request message that comprises the client operation report information element, the one or more second messages comprising the virtual basic service set request message.

9. The first wireless communication device of claim 1, wherein the one or more first messages comprise a set of virtual basic service set client-specific multi link operation parameters associated with the client wireless communication device, the set of virtual basic service set client-specific multi link operation parameters comprising a multi link device medium access control address parameter, and one or more link-specific parameters associated with each link of a multi link device, the client wireless communication device being the multi link device.

10. The first wireless communication device of claim 1, further comprising:
transmitting, to the second access point, a virtual basic service set request message that comprises a set of virtual basic service set-specific multi link operation parameters, the set of virtual basic service set-specific multi link operation parameters comprising a multi link device medium access control address parameter and one or more first link-specific parameters associated with each link of a multi link device, the virtual basic service set request message further comprising a set of virtual basic service set client-specific multi link operation parameters comprising a client multi link device medium access control address parameter and one or more second link-specific parameters associated with each link of the multi link device, the client wireless communication device being the multi link device.

11. The first wireless communication device of claim 1, wherein the one or more first messages comprise a traffic identifier to link mapping policy information element associated with a set of multi-link operation parameters associated with the client wireless communication device.

12. The first wireless communication device of claim 11, wherein the processing system is further configured to cause the first wireless communication device to transmit, to the second access point, a virtual basic service set request message that comprises the traffic identifier to link mapping policy information elements, the one or more second messages comprising the virtual basic service set request message.

13. The first wireless communication device of claim 1, wherein the processing system is further configured to cause the first wireless communication device to:
transmit, in association with addition of the client wireless communication device to the virtual basic service set, a control message to an access point associated with the virtual basic service set that indicates to transition a second client wireless communication device from the virtual basic service set to a basic service set associated with the access point, reception of the one or more first messages being in association with the addition of the client wireless communication device to the virtual basic service set.

14. The first wireless communication device of claim 13, wherein
transmitting the control message is in association with the addition of the client wireless communication device to the virtual basic service set exceeding a maximum quantity of client wireless communication devices for the virtual basic service set.

15. The first wireless communication device of claim 13, wherein
transmitting the control message is in association with a first mobility profile associated with the client wireless communication device, a second mobility profile associated with the second client wireless communication device, respective service level agreement priorities associated with the client wireless communication device and the second client wireless communication device, or any combination thereof.

16. The first wireless communication device of claim 1, wherein the processing system is further configured to cause the first wireless communication device to:
receive, from the first access point, a first indication of a first signal strength associated with a first link between the first access point and the client wireless communication device; and
receive, from the second access point, a second indication of a second signal strength associated with a second link between the second access point and the client wireless communication device, the transfer of service associated with the second signal strength being stronger than the first signal strength.

17. A first access point, comprising:
a processing system that includes processor circuitry and memory circuitry that stores code, the processing system configured to cause the first access point to:
receive, from a first wireless communication device, one or more request messages associated with transfer of service for a client wireless communication device from the first access point to a second access point in accordance with a virtual basic service set, wherein the virtual basic service set is associated with the first access point and the second access point; and
transmit, to the first wireless communication device, one or more first messages that indicate a set of security context parameters associated with the client wireless communication device and a set of operating parameters associated with the client wireless communication device.

18. The first access point of claim 17, wherein the processing system is further configured to cause the first access point to:
receive, from the first wireless communication device, a client security context request message, the one or more request messages comprising the client security context request message; and
transmit, to the first wireless communication device in association with the client security context request message, a client security context response message that includes the set of security context parameters, the one or more first messages comprising the client security context response message.

19. The first access point of claim 18, wherein the client security context response message comprises a client security context information element that comprises a beacon interval group temporal key parameter, an integrity group temporal key, a pairwise master key parameter, a receiver packet number parameter, or a combination thereof.

20. The first access point of claim 18, wherein the client security context response message comprises a client security context information element and a client additional security context information element, the client additional security context information element comprising a beacon interval group temporal key parameter, an integrity group temporal key, a pairwise master key parameter, a receiver packet number parameter, or a combination thereof.

21. The first access point of claim 17, wherein the one or more first messages comprise a client operation report information element associated with the set of operating parameters, the client operation report information element comprising a receiver number of spatial streams type parameter, a receiver number of spatial streams parameter, a low density parity check encoding parameter, a channel width parameter, a spatial multiplexing power saving parameter, one or more individual target wake time parameters, one or more broadcast target wake time parameters, or a combination thereof.

22. The first access point of claim 17, wherein the one or more first messages comprise a set of virtual basic service set client-specific multi link operation parameters associated with the client wireless communication device, the set of virtual basic service set client-specific multi link operation parameters comprising a multi link device medium access control address parameter and one or more link-specific parameters associated with each link of a multi link device, the client wireless communication device being the multi link device.

23. The first access point of claim 17, wherein the one or more first messages comprise a traffic identifier to link mapping policy information element associated with a set of multi-link operation parameters associated with the client wireless communication device.

24. The first access point of claim 17, wherein the processing system is further configured to cause the first access point to terminate, in association with transmission of the one or more first messages, communication with the client wireless communication device in accordance with a basic service set.

25. The first access point of claim 17, wherein the processing system is further configured to cause the first access point to transmit, to the first wireless communication device, an indication of a signal strength associated with a first link between the first access point and the client wireless communication device, wherein the transfer of service to the second access point is in association with the indication.

26. A second access point, comprising:
a processing system that includes processor circuitry and memory circuitry that stores code, the processing system configured to cause the second access point to:
receive, from a first wireless communication device, one or more messages associated with transfer of service for a client wireless communication device from a first access point to the second access point in association with a virtual basic service set, wherein the one or more messages indicate a set of security context parameters associated with the client wireless communication device and a set of operating parameters associated with the client wireless communication device; and
communicate with the client wireless communication device in accordance with the virtual basic service set in association with the one or more messages.

27. The second access point of claim 26, wherein the processing system is further configured to cause the second access point to receive, from the first wireless communication device, a virtual basic service set request message that comprises an extended virtual basic service set information element, the extended virtual basic service set information element comprising a beacon interval group temporal key parameter, an integrity group temporal key parameter, a pairwise master key parameter, a receiver packet number parameter, or a combination thereof, the one or more messages comprising the virtual basic service set request message.

28. The second access point of claim 26, wherein the processing system is further configured to cause the second access point to receive, from the first wireless communication device, a virtual basic service set request message that comprises a client security context information element and a client additional security context information element, the client additional security context information element comprising a beacon interval group temporal key parameter, an integrity group temporal key, a pairwise master key parameter, a receiver packet number parameter, or a combination thereof, the one or more messages comprising the virtual basic service set request message.

29. The second access point of claim 26, wherein the processing system is further configured to cause the second access point to receive, from the first wireless communication device, a virtual basic service set request message that comprises a client operation report information element associated with the set of operating parameters, the client operation report information element comprising a receiver number of spatial streams type parameter, a receiver number of spatial streams parameter, a low density parity check encoding parameter, a channel width parameter, a spatial multiplexing power saving parameter, one or more individual target wake time parameters, one or more broadcast target wake time parameters, or a combination thereof, the one or more messages comprising the virtual basic service set request message.

30. The second access point of claim 26, wherein the processing system is further configured to cause the second access point to receive, from the first wireless communication device, a virtual basic service set request message that comprises a set of virtual basic service set-specific multi link operation parameters, the set of virtual basic service set-specific multi link operation parameters comprising a multi link device medium access control address parameter and one or more first link-specific parameters associated with each link of a multi link device, the client wireless communication device being the multi link device, the virtual basic service set request message further comprising a set of virtual basic service set client-specific multi link operation parameters comprising a client multi link device medium access control address parameter and one or more second link-specific parameters associated with each link of the multi link device.
